(19) United States
(12) Patent Application Publication
(10) Pub. No.: US 2019/0386881 A1
(43) Pub. Date: Dec. 19, 2019

(54) LEAF NODE DISCOVERY FOR MULTICAST TREES

(71) Applicant: NOKIA SOLUTIONS AND NETWORKS OY, Espoo (FI)

(72) Inventor: Pranjal Dutta, Sunnyvale, CA (US)

(21) Appl. No.: 16/008,204

(22) Filed: Jun. 14, 2018

(51) Int. Cl. H04L 12/24; H04L 12/759; H04L 12/18

(52) U.S. Cl. CPC H04L 41/12; H04L 12/18; H04L 45/028

(57) ABSTRACT

Various example embodiments for supporting leaf node discovery for multicast trees in packet switched communication networks are described. Various example embodiments for supporting leaf node discovery for multicast trees may be configured to enable the root node of a multicast tree to be informed explicitly whenever a leaf router joins or leaves the multicast tree, thereby supporting efficient and reliable leaf node discovery. Various example embodiments for supporting leaf node discovery for a multicast tree may support discovery of leaf nodes of the multicast tree based on a process in which a transit node sends a membership change message for the multicast tree to a root node of the multicast tree based on detection of a condition and in which the root node of the multicast tree, based on the membership change message, initiates a leaf node discovery process for discovering the leaf nodes of the multicast tree.

### TECHNICAL FIELD

Various example embodiments relate generally to communication networks and, more particularly but not exclusively, to leaf node discovery for multicast trees in packet switched communication networks.

### BACKGROUND

In many communication networks, various communications technologies may be used to support communications.

### SUMMARY

Various example embodiments relate generally to leaf node discovery for multicast trees in packet switched communication networks.

In at least some example embodiments, an apparatus is provided. The apparatus includes at least one processor. The apparatus includes at least one memory including computer program code. The at least one memory and the computer program code are configured to, with the at least one processor, cause the apparatus to at least detect, by a transit node of a multicast tree, a condition associated with a request for a membership change for a leaf node of the multicast tree and send, by the transit node toward a root node of the multicast tree based on detection of the condition associated with the request for the membership change for the leaf node of the multicast tree, a membership change message indicative of a membership change in the multicast tree. The condition associated with the request for the membership change for the leaf node of the multicast tree may include receipt of a join message for the multicast tree and a determination that a state of the multicast tree exists at the transit node. The condition associated with the request for the membership change for the leaf node of the multicast tree may include receipt of a prune message for the multicast tree and a determination that at least one downstream stream is active from the transit node for the multicast tree. The membership change message may be sent toward the root node of the multicast tree using in-band signaling based on a multicast tree control protocol. The at least one memory and the computer program code may be configured to, with the at least one processor, cause the apparatus to at least start, by the transit node based on the sending of the membership change message indicative of the membership change in the multicast tree, a membership change suppression timer for the multicast tree, detect, by the transit node, a second condition associated with a second request for a membership change for a second leaf node of the multicast tree, and prevent, by the transit node based on the membership change suppression timer, sending of a second membership change message toward the root node. The at least one memory and the computer program code may be configured to, with the at least one processor, cause the apparatus to at least receive, by the transit node from an upstream node of the multicast tree, a membership probe message indicative of a request by the root node for leaf nodes of the multicast tree to respond with indications of being members of the multicast tree and send, by the transit node toward a downstream node of the multicast tree, the membership probe message. The membership probe message may be sent based on a determination that the transit node includes downstream forwarding state for the multicast tree and a determination that the transit node is not a leaf node of the multicast tree. The at least one memory and the computer program code may be configured to, with the at least one processor, cause the apparatus to at least receive, by the transit node from a downstream node of the multicast tree, a membership discovery message including leaf membership information of the leaf node and send, by the transit node toward the root node, the membership discovery message. The membership discovery message may be sent based on a determination that the transit node is not the root node of the multicast tree. The at least one memory and the computer program code may be configured to, with the at least one processor, cause the apparatus to at least detect, by the transit node of the multicast tree, a condition associated with a loss of a multicast control plane session to a downstream peer and send, by the transit node toward a root node of the multicast tree based on detection of the condition associated with the loss of the multicast control plane session to the downstream peer, a second membership change message.

In at least some example embodiments, a method is provided. The method includes detecting, by a transit node of a multicast tree, a condition associated with a request for a membership change for a leaf node of the multicast tree and sending, by the transit node toward a root node of the multicast tree based on detection of the condition associated with the request for the membership change for the leaf node of the multicast tree, a membership change message indicative of a membership change in the multicast tree. The condition associated with the request for the membership change for the leaf node of the multicast tree may include receipt of a join message for the multicast tree and a determination that a state of the multicast tree exists at the transit node. The condition associated with the request for the membership change for the leaf node of the multicast tree may include receipt of a prune message for the multicast tree and a determination that at least one downstream stream is active from the transit node for the multicast tree. The membership change message may be sent toward the root node of the multicast tree using in-band signaling based on a multicast tree control protocol. The method may include starting, by the transit node based on the sending of the membership change message indicative of the membership change in the multicast tree, a membership change suppression timer for the multicast tree, detecting, by the transit node, a second condition associated with a second request for a membership change for a second leaf node of the multicast tree, and preventing, by the transit node based on the membership change suppression timer, sending of a second membership change message toward the root node. The method may include receiving, by the transit node from an upstream node of the multicast tree, a membership probe message indicative of a request by the root node for leaf nodes of the multicast tree to respond with indications of being members of the multicast tree and sending, by the transit node toward a downstream node of the multicast tree, the membership probe message. The membership probe message may be sent based on a determination that the transit node includes downstream forwarding state for the multicast tree and a determination that the transit node is not a leaf node of the multicast tree. The method may include receiving, by the transit node from a downstream node of the multicast tree, a membership discovery message including leaf membership information of the leaf node and sending, by the transit node toward the root node, the membership discovery message. The membership discovery message may be sent based on a determination that the transit node is not the root node of the multicast tree. The method may include detecting, by the transit node of the multicast tree, a condition associated with a loss of a multicast control plane session to a downstream peer and sending, by the transit node toward a root node of the multicast tree based on detection of the condition associated with the loss of the multicast control plane session to the downstream peer, a second membership change message.

In at least some example embodiments, a non-transitory computer readable medium is provided. The non-transitory computer-readable medium includes program instructions for causing an apparatus to at least detect, by a transit node of a multicast tree, a condition associated with a request for a membership change for a leaf node of the multicast tree and send, by the transit node toward a root node of the multicast tree based on detection of the condition associated with the request for the membership change for the leaf node of the multicast tree, a membership change message indicative of a membership change in the multicast tree. The condition associated with the request for the membership change for the leaf node of the multicast tree may include receipt of a join message for the multicast tree and a determination that a state of the multicast tree exists at the transit node. The condition associated with the request for the membership change for the leaf node of the multicast tree may include receipt of a prune message for the multicast tree and a determination that at least one downstream stream is active from the transit node for the multicast tree. The membership change message may be sent toward the root node of the multicast tree using in-band signaling based on a multicast tree control protocol. The non-transitory computer-readable medium may include program instructions for causing the apparatus to at least start, by the transit node based on the sending of the membership change message indicative of the membership change in the multicast tree, a membership change suppression timer for the multicast tree, detect, by the transit node, a second condition associated with a second request for a membership change for a second leaf node of the multicast tree, and prevent, by the transit node based on the membership change suppression timer, sending of a second membership change message toward the root node. The non-transitory computer-readable medium may include program instructions for causing the apparatus to at least receive, by the transit node from an upstream node of the multicast tree, a membership probe message indicative of a request by the root node for leaf nodes of the multicast tree to respond with indications of being members of the multicast tree and send, by the transit node toward a downstream node of the multicast tree, the membership probe message. The membership probe message may be sent based on a determination that the transit node includes downstream forwarding state for the multicast tree and a determination that the transit node is not a leaf node of the multicast tree. The non-transitory computer-readable medium may include program instructions for causing the apparatus to at least receive, by the transit node from a downstream node of the multicast tree, a membership discovery message including leaf membership information of the leaf node and send, by the transit node toward the root node, the membership discovery message. The membership discovery message may be sent based on a determination that the transit node is not the root node of the multicast tree. The non-transitory computer-readable medium may include program instructions for causing the apparatus to at least detect, by the transit node of the multicast tree, a condition associated with a loss of a multicast control plane session to a downstream peer and send, by the transit node toward a root node of the multicast tree based on detection of the condition associated with the loss of the multicast control plane session to the downstream peer, a second membership change message.

In at least some example embodiments, an apparatus is provided. The apparatus includes means for detecting, by a transit node of a multicast tree, a condition associated with a request for a membership change for a leaf node of the multicast tree and means for sending, by the transit node toward a root node of the multicast tree based on detection of the condition associated with the request for the membership change for the leaf node of the multicast tree, a membership change message indicative of a membership change in the multicast tree. The condition associated with the request for the membership change for the leaf node of the multicast tree may include receipt of a join message for the multicast tree and a determination that a state of the multicast tree exists at the transit node. The condition associated with the request for the membership change for the leaf node of the multicast tree may include receipt of a prune message for the multicast tree and a determination that at least one downstream stream is active from the transit node for the multicast tree. The membership change message may be sent toward the root node of the multicast tree using in-band signaling based on a multicast tree control protocol. The apparatus may include means for starting, by the transit node based on the sending of the membership change message indicative of the membership change in the multicast tree, a membership change suppression timer for the multicast tree, means for detecting, by the transit node, a second condition associated with a second request for a membership change for a second leaf node of the multicast tree, and means for preventing, by the transit node based on the membership change suppression timer, sending of a second membership change message toward the root node. The apparatus may include means for receiving, by the transit node from an upstream node of the multicast tree, a membership probe message indicative of a request by the root node for leaf nodes of the multicast tree to respond with indications of being members of the multicast tree and means for sending, by the transit node toward a downstream node of the multicast tree, the membership probe message. The membership probe message may be sent based on a determination that the transit node includes downstream forwarding state for the multicast tree and a determination that the transit node is not a leaf node of the multicast tree. The apparatus may include means for receiving, by the transit node from a downstream node of the multicast tree, a membership discovery message including leaf membership information of the leaf node and means for sending, by the transit node toward the root node, the membership discovery message. The membership discovery message may be sent based on a determination that the transit node is not the root node of the multicast tree. The apparatus may include means for detecting, by the transit node of the multicast tree, a condition associated with a loss of a multicast control plane session to a downstream peer and means for sending, by the transit node toward a root node of the multicast tree based on detection of the condition associated with the loss of the multicast control plane session to the downstream peer, a second membership change message.

In at least some example embodiments, an apparatus is provided. The apparatus includes at least one processor. The apparatus includes at least one memory including computer program code. The at least one memory and the computer program code are configured to, with the at least one processor, cause the apparatus to at least receive, by a root node of a multicast tree from a transit node of the multicast tree, a membership change message indicative of a membership change in the multicast tree and send, by the root node of the multicast tree, a membership probe message indicative of a request by the root node for leaf nodes of the multicast tree to respond with indications of being members of the multicast tree. The membership change message may be received in-band via an upstream path of the multicast tree. The membership probe message may be sent in-band along a downstream path of the multicast tree. The at least one memory and the computer program code may be configured to, with the at least one processor, cause the apparatus to at least start, by the root node based on the membership probe message being sent, a membership discovery timer for the multicast tree, wherein the membership discovery timer is configured for use by the root node to identify an end of a leaf node discovery process. The at least one memory and the computer program code are configured to, with the at least one processor, cause the apparatus to at least start, by the root node based on the membership probe message being sent, a membership probe suppression timer for the multicast tree, receive, by the root node, a second membership change message indicative of a membership change in the multicast tree, and suppress, by the root node based on the membership probe suppression timer, sending of a second membership probe message. The at least one memory and the computer program code may be configured to, with the at least one processor, cause the apparatus to at least send, by the root node based on expiration of the membership probe suppression timer, the second membership probe message. The at least one memory and the computer program code may be configured to, with the at least one processor, cause the apparatus to at least receive, by the root node from a leaf node of the multicast tree, a membership discovery message including leaf membership information of the leaf node for the multicast tree and register, by the root node in a leaf node membership database for the root node, the leaf membership information of the leaf node. The membership discovery message may be received in-band via an upstream path of the multicast tree. The at least one memory and the computer program code may be configured to, with the at least one processor, cause the apparatus to at least initiate, by the root node, a leaf node verification process configured to verify that the leaf nodes of the multicast tree are reachable in a data plane of the multicast tree.

In at least some example embodiments, a method is provided. The method includes receiving, by a root node of a multicast tree from a transit node of the multicast tree, a membership change message indicative of a membership change in the multicast tree and sending, by the root node of the multicast tree, a membership probe message indicative of a request by the root node for leaf nodes of the multicast tree to respond with indications of being members of the multicast tree. The membership change message may be received in-band via an upstream path of the multicast tree. The membership probe message may be sent in-band along a downstream path of the multicast tree. The method may include starting, by the root node based on the membership probe message being sent, a membership discovery timer for the multicast tree, wherein the membership discovery timer is configured for use by the root node to identify an end of a leaf node discovery process. The method may include starting, by the root node based on the membership probe message being sent, a membership probe suppression timer for the multicast tree, receiving, by the root node, a second membership change message indicative of a membership change in the multicast tree, and suppressing, by the root node based on the membership probe suppression timer, sending of a second membership probe message. The method may include sending, by the root node based on expiration of the membership probe suppression timer, the second membership probe message. The method may include receiving, by the root node from a leaf node of the multicast tree, a membership discovery message including leaf membership information of the leaf node for the multicast tree and registering, by the root node in a leaf node membership database for the root node, the leaf membership information of the leaf node. The membership discovery message may be received in-band via an upstream path of the multicast tree. The method may include initiating, by the root node, a leaf node verification process configured to verify that the leaf nodes of the multicast tree are reachable in a data plane of the multicast tree.

In at least some example embodiments, a non-transitory computer readable medium is provided. The non-transitory computer-readable medium includes program instructions for causing an apparatus to at least receive, by a root node of a multicast tree from a transit node of the multicast tree, a membership change message indicative of a membership change in the multicast tree and send, by the root node of the multicast tree, a membership probe message indicative of a request by the root node for leaf nodes of the multicast tree to respond with indications of being members of the multicast tree. The membership change message may be received in-band via an upstream path of the multicast tree. The membership probe message may be sent in-band along a downstream path of the multicast tree. The non-transitory computer-readable medium may include program instructions for causing the apparatus to at least start, by the root node based on the membership probe message being sent, a membership discovery timer for the multicast tree, wherein the membership discovery timer is configured for use by the root node to identify an end of a leaf node discovery process. The non-transitory computer-readable medium may include program instructions for causing the apparatus to at least start, by the root node based on the membership probe message being sent, a membership probe suppression timer for the multicast tree, receive, by the root node, a second membership change message indicative of a membership change in the multicast tree, and suppress, by the root node based on the membership probe suppression timer, sending of a second membership probe message. The non-transitory computer-readable medium may include program instructions for causing the apparatus to at least send, by the root node based on expiration of the membership probe suppression timer, the second membership probe message. The non-transitory computer-readable medium may include program instructions for causing the apparatus to at least receive, by the root node from a leaf node of the multicast tree, a membership discovery message including leaf membership information of the leaf node for the multicast tree and register, by the root node in a leaf node membership database for the root node, the leaf membership information of the leaf node. The membership discovery message may be received in-band via an upstream path of the multicast tree. The non-transitory computer-readable medium may include program instructions for causing the apparatus to at least initiate, by the root node, a leaf node verification process configured to verify that the leaf nodes of the multicast tree are reachable in a data plane of the multicast tree.

In at least some example embodiments, an apparatus is provided. The apparatus includes means for receiving, by a root node of a multicast tree from a transit node of the multicast tree, a membership change message indicative of a membership change in the multicast tree and means for sending, by the root node of the multicast tree, a membership probe message indicative of a request by the root node for leaf nodes of the multicast tree to respond with indications of being members of the multicast tree. The membership change message may be received in-band via an upstream path of the multicast tree. The membership probe message may be sent in-band along a downstream path of the multicast tree. The apparatus may include means for starting, by the root node based on the membership probe message being sent, a membership discovery timer for the multicast tree, wherein the membership discovery timer is configured for use by the root node to identify an end of a leaf node discovery process. The apparatus may include means for starting, by the root node based on the membership probe message being sent, a membership probe suppression timer for the multicast tree, means for receiving, by the root node, a second membership change message indicative of a membership change in the multicast tree, and means for suppressing, by the root node based on the membership probe suppression timer, sending of a second membership probe message. The apparatus may include means for sending, by the root node based on expiration of the membership probe suppression timer, the second membership probe message. The apparatus may include means for receiving, by the root node from a leaf node of the multicast tree, a membership discovery message including leaf membership information of the leaf node for the multicast tree and means for registering, by the root node in a leaf node membership database for the root node, the leaf membership information of the leaf node. The membership discovery message may be received in-band via an upstream path of the multicast tree. The apparatus may include means for initiating, by the root node, a leaf node verification process configured to verify that the leaf nodes of the multicast tree are reachable in a data plane of the multicast tree.

In at least some example embodiments, an apparatus is provided. The apparatus includes at least one processor. The apparatus includes at least one memory including computer program code. The at least one memory and the computer program code are configured to, with the at least one processor, cause the apparatus to at least receive, by a leaf node of a multicast tree, a membership probe message indicative of a request by a root node of the multicast tree for the leaf node to respond with an indication of a membership status of the leaf node in the multicast tree and send, by the leaf node toward the root node based on the membership probe message, a membership discovery message including leaf membership information of the leaf node for the multicast tree.

In at least some example embodiments, a method is provided. The method includes receiving, by a leaf node of a multicast tree, a membership probe message indicative of a request by a root node of the multicast tree for the leaf node to respond with an indication of a membership status of the leaf node in the multicast tree and sending, by the leaf node toward the root node based on the membership probe message, a membership discovery message including leaf membership information of the leaf node for the multicast tree.

In at least some example embodiments, a non-transitory computer readable medium is provided. The non-transitory computer-readable medium includes program instructions for causing an apparatus to at least receive, by a leaf node of a multicast tree, a membership probe message indicative of a request by a root node of the multicast tree for the leaf node to respond with an indication of a membership status of the leaf node in the multicast tree and send, by the leaf node toward the root node based on the membership probe message, a membership discovery message including leaf membership information of the leaf node for the multicast tree.

In at least some example embodiments, an apparatus is provided. The apparatus includes means for receiving, by a leaf node of a multicast tree, a membership probe message indicative of a request by a root node of the multicast tree for the leaf node to respond with an indication of a membership status of the leaf node in the multicast tree. The apparatus includes means for sending, by the leaf node toward the root node based on the membership probe message, a membership discovery message including leaf membership information of the leaf node for the multicast tree.

### BRIEF DESCRIPTION OF THE DRAWINGS

The teachings herein can be readily understood by considering the following detailed description in conjunction with the accompanying drawings, in which:

FIG. 1 depicts an example embodiment of a communication system including a packet delivery network configured to support packet forwarding based on multicast and configured to support leaf node discovery for multicast trees;

FIG. 2 depicts an example embodiment of leaf node discovery for a multicast tree within the packet delivery network of the communication system of FIG. 1;

FIG. 3 depicts an example embodiment of a process for leaf node discovery for a multicast tree; and

FIG. 4 depicts a high-level block diagram of a computer suitable for use in performing various functions presented herein.

To facilitate understanding, identical reference numerals have been used, where possible, to designate identical elements that are common to the figures.

### DETAILED DESCRIPTION

Various example embodiments for supporting leaf node discovery for multicast trees in packet switched communication networks are described. Various example embodiments for supporting leaf node discovery for multicast trees may be configured to enable the root node of a multicast tree to be informed explicitly whenever a leaf router joins or leaves the multicast tree, thereby enabling efficient, reliable, and scalable leaf node discovery. Various example embodiments for supporting leaf node discovery for a multicast tree may support discovery of leaf nodes of the multicast tree based on a process in which a transit node sends a membership change message for the multicast tree to a root node of the multicast tree based on detection of a condition associated with a request for a membership change for a leaf node of the multicast tree and in which the root node of the multicast tree, based on the membership change message, initiates a leaf node discovery process for discovering the leaf nodes of the multicast tree (e.g., a leaf node discovery process in which the root node sends a membership probe message indicative of a request by the root node for leaf nodes of the multicast tree to respond with indications of being members of the multicast tree, receives membership discovery messages from leaf nodes of the multicast tree, and registers the leaf node membership information of the leaf nodes in a leaf node database for the multicast tree). The various nodes of a multicast tree (e.g., the transit nodes, the root node, and the leaf nodes of the multicast tree), as discussed further below, may perform various other functions for supporting leaf node discovery for the multicast tree. Various example embodiments for supporting leaf node discovery for a multicast tree may be configured to support leaf node discovery for various types of multicast (e.g., Internet Protocol (IP) multicast, Multiprotocol Label Switching (MPLS) multicast, or the like), various types of multicast trees (e.g., P2MP trees, multipoint-to-multipoint (MP2MP) trees, or the like), various multicast control protocols configured to support management of multicast trees (e.g., Protocol Independent Multicast (PIM), Multicast Label Distribution Protocol (mLDP), or the like), or the like, as well as various combinations thereof. Various example embodiments for supporting leaf node discovery for multicast trees may be configured to support in-band discovery of leaf nodes of a multicast tree, where in-band discovery refers to performing the leaf node discovery process along the multicast tree (namely, along the paths, including the downstream paths and upstream paths, of the multicast tree) using a leaf node discovery protocol where the leaf node discovery protocol may be the same multicast control protocol that was used to signal the multicast tree (e.g., mLDP where mLDP was used to signal the multicast tree, PIM where PIM was used to signal the multicast tree, or the like) or a different control protocol that operates along the control plane states of the multicast tree (e.g., PIM or a generic protocol where mLDP was used to signal the multicast tree, mLDP or a generic protocol where PIM was used to signal the multicast tree, a generic control protocol, or the like). It is noted that use of in-band signaling for leaf node discovery ensures that the leaf node discovery messages reach the leaf nodes of the multicast tree even where the root node that triggered leaf node discovery might not have accurate multicast tree membership information in its associated leaf node database. Various example embodiments for supporting leaf node discovery for multicast trees are configured to support discovery of leaf nodes of a multicast tree in a manner that is independent of the application that uses the multicast tree. It will be appreciated that these and various other example embodiments and advantages or potential advantages of leaf node discovery for multicast trees in packet switched communication networks may be further understood by way of reference to the various figures, which are discussed further below.

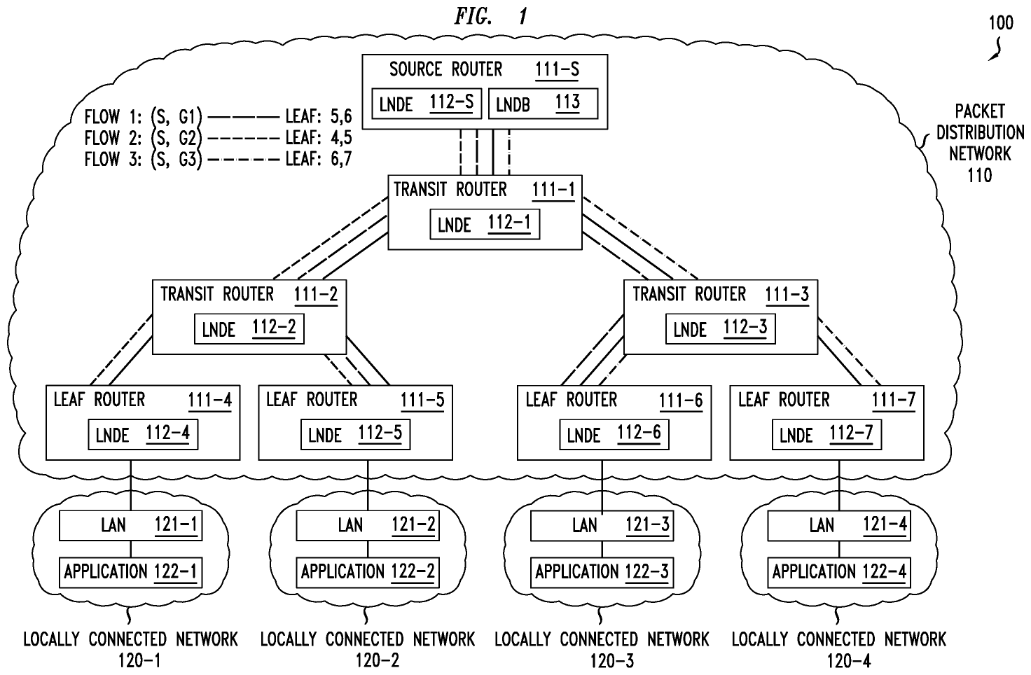

FIG. 1 depicts an example embodiment of a communication system including a packet delivery network configured to support packet forwarding based on multicast and configured to support leaf node discovery for multicast trees.

The communication system 100 includes a packet delivery network 110 and an associated set of locally connected networks 120-1-120-4 (collectively, locally connected networks 120). The packet delivery network 110 includes a set of routers 111 including a source router 111-S (which also may be referred to in certain notations herein as router or multicast router S or as multicast source S), a set of transit routers (illustratively, transit routers 111-1-111-3, which also may be referred to in certain notations herein as routers or transit routers 1, 2, and 3, respectively), and a set of leaf routers (illustratively, leaf routers 111-4-111-7, which also may be referred to in certain notations herein as routers or leaf routers 4, 5, 6, and 7, respectively). It is further noted that, within the context of MPLS, the routers 111 also may be referred to as label switched routers (LSRs 111-1 to 111-7 or LSR S and LSRs 1-7). The routers 111 of the packet delivery network 110 are communicatively connected in a particular topology via communication links (illustratively, the source router 111-S is communicatively connected to the transit router 111-1, the transit router 111-1 is communicatively connected to the transit routers 111-2 and 111-3, the transit router 111-2 is communicatively connected to the leaf routers 111-4 and 111-5, and the transit router 111-3 is communicatively connected to the leaf routers 111-6 and 111-7). The locally connected networks 120-1-120-4 include local area networks (LANs) 121-1-121-4 (collectively, LANs 121) and applications 122-1-122-4 (collectively, applications 122), respectively. The locally connected networks 120-1-120-4 are served by the leaf routers 111-4-111-7, respectively. It is noted that the leaf routers 111-4-111-7 also may be referred to herein as edge routers or egress routers, as the term “leaf” implies their participation in a multicast tree, when discussion such routers when those routers are not associated with any particular multicast tree. It will be appreciated that the packet delivery network 110 and the locally connected networks 120 may be arranged in various other ways (e.g., using different numbers, types, or arrangements of nodes).

The packet delivery network 110 is a packet delivery network configured to support delivery of packets using multicast. In general, multicast is a method of sending packets to a group of interested receivers in a single transmission. Multicast uses network infrastructure efficiently by having the source send a packet only once, even if it needs to be delivered to multiple receivers. The nodes in the network take care of replicating the packet, when needed, such that the packet may be delivered from the source to multiple receivers. The multicast flow may be set up by the multicast control plane, which may be composed of various multicast control protocols, such as Internet Group Membership Protocol (IGMP), PIM, mLDP, or the like, as well as various combinations thereof. The leaf routers rely on a multicast control protocol to learn the interests of locally connected hosts/receivers (e.g., in the respective LANs 121-1-121-4 for leaf routers 111-4-111-7) for a multicast group address G (which is sometimes referred to more generally as multicast group G). For example, leaf routers 111-4-111-7 may each receive interest for a multicast group address G through multicast join messages from host(s) in their LANs 121-1-121-4, respectively. These multicast join messages trigger the leaf routers 111-4-111-7 to each send multicast join messages for the multicast group address G toward the multicast source S. The multicast join messages sent by the leaf routers for the multicast group address G traverse the nodes along the shortest paths to multicast source S, respectively, while installing multicast group state in the control planes and the data planes of each of the traversed nodes (transit routers) traversed by the multicast join messages sent by the leaf routers. As discussed further below, examples of three such flows are illustrated in FIG. 1. Namely, FIG. 1 illustrates three multicast flows from multicast source S to respective subsets of the leaf routers (i.e., leaf routers 111-4-111-7) as follows: (1) Flow 1 for multicast group (S, G1) to leaf routers 111-5 and 111-6, (2) Flow 2 for multicast group (S, G2) to leaf routers 111-4 and 111-5, and (3) Flow 3 for multicast group (S, G3) to leaf routers 111-6 and 111-7. The packet delivery network 110, as discussed further below, may be configured to support various types of multicast, such as IP multicast, MPLS multicast, or the like, as well as various combinations thereof.

The packet delivery network 110 is configured to support various example embodiments for supporting leaf node discovery for multicast trees. The routers 111 of packet delivery network 110 may be configured to support various example embodiments for supporting leaf node discovery for multicast trees in packet delivery network 110. The routers 111 include leaf node discovery elements (LNDEs) 112 (illustratively, LNDE 112-S on source router 111-S, LNDEs 112-1-112-3 on transit routers 111-1-111-3, and LNDEs 112-4-112-7 on leaf routers 111-4-111-7, respectively) configured to support leaf node discovery for multicast trees in the packet delivery network 110. The LNDEs 112 may be configured to support leaf node discovery functions which enable the root node of a multicast tree (illustratively, router 111-S) to be informed explicitly when a leaf router (illustratively, routers 111-4-111-7) joins or leave a multicast tree, thereby supporting efficient, reliable, and scalable leaf node discovery. The LNDEs 112 may be configured to support various embodiments of leaf node discovery for various types of multicast (e.g., IP multicast, MPLS multicast, or the like), for various types of multicast trees (e.g., P2MP, MP2MP, or the like), for various types of multicast control protocols (e.g., PIM, mLDP, or the like), or the like, as well as various combinations thereof. It will be appreciated that various example embodiments for supporting leaf node discovery may be further understood by further considering use of such embodiments within the context of certain types of multicast (e.g., IP multicast, MPLS multicast, or the like), which are discussed further hereinbelow. The source router 111-S also may include a leaf node database (LNDB) 113 that is configured to maintain leaf node membership information for multicast trees for which source router 111-S is the root node.

IP multicast is the IP-specific version of the general concept of multicast networking. IP multicast uses reserved multicast address blocks in IPv4 and IPv6 as the destination address (i.e., multicast group address G) in the IP header. In P2MP IP multicast, a single IP packet is sent by a multicast source S to the multicast group address G, and the IP packet is received by all of the nodes that are members of multicast group address G. As such, a multicast flow may be described as (S, G), i.e., a flow from a multicast source S to the multicast group address G. As discussed further below, examples of three such flows are illustrated in FIG. 1. Namely, FIG. 1 illustrates three multicast flows from multicast source S to respective leaf routers (i.e., leaf routers 111-4-111-7). The multicast flows are set-up by the IP multicast control plane. The IP multicast control plane may be composed of several control protocols, such as IGMP, PIM or the like. The leaf routers 111-4-111-7 rely on IGMP to learn the interests of locally connected hosts/receivers (e.g., in the respective LANs 121-1-121-4 for leaf routers 111-4-111-7) for multicast groups. For example, leaf routers 111-4-111-7 each may receive interest on (S, G) through IGMP JOINs from host(s) in their LANs 121-1-121-4, respectively. These IGMP JOINs trigger the leaf routers 111-4-7 to each send PIM JOINs for (S, G) toward S. The PIM JOINs for (S, G) traverse the nodes along the shortest paths to multicast source S, respectively, while installing (S, G) state in the control planes and the data planes of each of the traversed nodes (transit routers) traversed by the PIM JOINs for (S, G). This results in a Multicast Distribution Tree (MDT) for the (S, G), where the root of the MDT is the multicast source S (namely, router 1) and every leaf node (namely, leaf routers 111-4-111-7) is an egress router interested in G. In FIG. 1, for example, leaf routers 111-5 and 111-6 each receive interest on (S, G1) through IGMP JOINs from host(s) in their LANs 121-2 and 121-3, respectively. These IGMP JOINs trigger leaf routers 111-5 and 111-6 to send PIM JOINs for (S, G1) toward transit routers 111-2 and 111-3, respectively. It is noted that, here, transit router 111-2 is the immediate next-hop in the shortest path to multicast source S from leaf router 111-5, and transit router 111-3 is the immediate next-hop in the shortest path to multicast source S from leaf router 111-6. Transit router 111-2, responsive to the PIM JOIN for (S, G1) from leaf router 111-5, installs state for (S, G1) in both the control plane and the data plane (with leaf router 111-5 as the downstream router for (S, G1)) of transit router 111-2. Transit router 111-3, responsive to the PIM JOIN for (S, G1) from leaf router 111-6, installs state for (S, G1) in both the control plane and the data plane (with leaf router 111-6 as the downstream router for (S, G1)) of router transit router 111-3. In a similar manner, transit routers 111-2 and 111-3 each send PIM JOINs for (S, G1) to transit router 111-1 (which, again, is the immediate next-hop of transit routers 111-2 and 111-3 in the shortest path to multicast source S) and transit router 111-1 installs state for (S, G1) in both the control plane and the data plane (with transit routers 111-2 and 111-3 as the downstream routers for (S, G1)) of transit router 111-1. In a similar manner, transit router 111-1 sends PIM JOIN for (S, G1) to source router 111-S and source router 111-S installs state for (S, G1) in both the control plane and the data plane (with transit router 111-1 as the downstream router for (S, G1)) of source router 111-S. This makes the MDT for (S, G1) complete. It will be appreciated that the MDTs for (S, G2) and (S, G3) may be established in a similar manner. However, when a transit router receives a PIM JOIN and the state of the MDT already exists in that transit router (e.g., due to PIM JOINs from other routers) then the set-up of the MDT is complete and, thus, no further signaling takes place upstream toward the root router. Thus, in PIM-signaled MDTs, a root router is agnostic of leaf node information of the MDT since other leaf routers may join without notifications being sent upstream to the root router. IP multicast may be used within various contexts, such as in applications of streaming media (e.g., IP television (IPTV), multi-point video conferencing, or the like) as well as other applications and contexts. Various example embodiments for supporting leaf node discovery for multicast trees may be applied within the context of IP multicast.

MPLS multicast is the MPLS-specific version of IP multicast networking, where multicast forwarding is based on MPLS labels. In MPLS, an MDT is either a P2MP LSP or a MP2MP LSP. In MPLS, the routers are referred to as Label Switched Routers (LSRs). In a P2MP LSP, there a single root LSR that transmits a packet to multiple leaf LSRs. In a MP2MP LSP, each leaf LSR also acts as root LSR and, thus, each leaf node of a MP2MP LSP can multicast to the rest of the leaf nodes. An LSR that is both a leaf LSR and a transit LSR is called a “bud” LSR (and it will be appreciated that references herein to leaf LSRs of a multicast tree may be understood to refer to LSRs that are operating as leaf nodes for that multicast tree, but which could be considered to be bud LSRs in that they may operate as transit nodes for other multicast trees). P2MP and MP2MP LSPs are collectively referred as Multi-Point LSPs (MP LSPs). MP LSPs are set up by multicast control protocols, such as P2MP Resource Reservation Protocol (P2MP-RSVP), mLDP, or the like. P2MP-RSVP is described in RFC 4875. mLDP is described in RFC 6388. MPLS multicast may be used within various contexts, such as in applications of streaming media (e.g., IP television (IPTV), multi-point video conferencing, or the like) as well as other applications and contexts. Various example embodiments for supporting leaf node discovery for multicast trees may be applied within the context of MPLS multicast. The use of mLDP to support MPLS multicast is discussed further below.

In mLDP, a P2MP LSP is identified by a P2MP FEC Element and a MP2MP LSP is identified by a MP2MP FEC Element. This is described in Section 2 and Section 3 of the document entitled “Label Distribution Protocol Extensions for Point-to-Multipoint and Multipoint-to-Multipoint Label Switched Paths” (i.e., RFC 6388, which may be referred to herein as MLDP). As indicated above, for purposes of clarity, various example embodiments for supporting leaf node discovery for multicast trees are primarily presented herein within the context of a packet delivery network using mLDP for management of P2MP LSPs and, thus, the following notations may be used for a P2MP FEC Element: (1) a P2MP FEC Element <X, Y> is a FEC Element with root node address X and opaque value Y, (2) a P2MP Label Mapping <X, Y, L> is a Label Mapping message with a FEC TLV with a single P2MP FEC Element <X, Y> and Label TLV with label L, (3) a P2MP Label Withdraw <X, Y, L> is a Label Withdraw message with a FEC TLV with a single P2MP FEC Element <X, Y> and Label TLV with label L, (4) a P2MP LSP <X, Y> (or simply <X, Y>) is a P2MP LSP with root node address X and opaque value Y, (5) the notation L′->{<I1, L1><I2, L2> . . . , <In, Ln>} on LSR X means that on receiving a packet with label L′, X makes n copies of the packet and, for copy i of the packet, X swaps L′ with Li and sends it out over interface Ii, (6) mLDP JOIN <X, Y>=P2MP Label Mapping <X, Y, L> where L =Label TLV with label L assigned by the sender, and (7) mLDP PRUNE <X, Y>=Label Withdraw <X, Y, L> where L=Label TLV with label L assigned by sender.

In mLDP, the signaling paradigm is similar to that of PIM that is used in IP multicast, namely, set up of the MP LSP starts from the leaf LSR leaf (leaf-initiated). This may be further understood with respect to the example multicast flows of FIG. 1. In FIG. 1, each (S, G) is 1:1 mapped to a P2MP LSP. For example, Leaf LSRs 4 and 5 receive interest on (S, G2) through IGMP JOINs from host(s) in their LANs 121-1 and 121-2, respectively. The leaf LSRs 4 and 5 are configured to map (S, G2) to P2MP FEC Element <X, Y>. Consider here that X=S. This mapping may be established via static configuration or via wide range of control plane techniques. These IGMP JOINs trigger Leaf LSRs 4 and 5 to each send an mLDP JOIN <X, Y2> toward LSR 2, since LSR 2 is the immediate next-hop in the shortest path to root X from Leaf LSRs 4 and 5, respectively. LSR 2, responsive to the mLDP JOINs <X, Y2> from Leaf LSRs 4 and 5, installs state for P2MP LSP <X, Y2> in both the control plane and the data plane (with Leaf LSRs 4 and 5 as downstream routers for P2MP LSP <X, Y2>) of LSR 2. In a similar manner, LSR 2 sends an mLDP JOIN <X, Y2> to LSR 1 and LSR 1 installs state for P2MP LSP <X, Y2> in both the control plane and the data plane (with LSR 2 as the downstream router for P2MP LSP <X, Y2>) of LSR 1. In a similar manner, LSR 1 sends an mLDP JOIN <X, Y2> to LSR S and LSR S installs state for P2MP LSP <X, Y2> in both the control plane and the data plane (with LSR 1 as the downstream router for P2MP LSP <X, Y2>) of LSR S. This makes the P2MP LSP <X, Y2> complete. However, when a transit LSR receives an mLDP JOIN and the state of the P2MP LSP already exists in that transit LSR (e.g., due to mLDP JOINs from other LSRs) then the set-up of the P2MP LSP is complete and, thus, no further signaling takes place upstream toward the root LSR. Thus, in mLDP-signaled MP LSPs, a root LSR is agnostic of leaf node information of the LSP since other leaf LSRs may join without notifications being sent upstream to the root LSR. This limitation of mLDP-signaled MP LSPs may have implications in various mLDP use cases (e.g., residential IP-TV deployments, VPLS multicast, aggregation (or multiplexing) of applications, or the like, as well as various combinations thereof), which are discussed further below. It is noted that the same limitation in PIM-signaled IP multicast trees may have implications if the use cases mentioned above deploy PIM-signaled IP multicast trees.

For example, mLDP-based P2MP LSPs, as indicated above, may be deployed in residential IP-TV applications. An IP-TV channel is broadcasted on a specific (S, G) and, for each such (S, G), a P2MP LSP is set-up and maintained by mLDP. In FIG. 1, an IP Set-Top Box (IP-STB) joins a channel by sending an IGMP JOIN request for the specific (S, G3) to a gateway router (such as 6,7). The gateway router is the mLDP leaf LSR. If the leaf LSR has not yet joined the P2MP LSP, the leaf LSR sends an mLDP JOIN to an upstream LSR for delivery to the root LSR. For example, a typical IP-TV channel can have up to 40K subscribers and, thus, the number of leaf LSRs in a P2MP LSP can be 40K. In IP-TLV applications, the leaf LSR memberships can change quickly as STBs join and leave channels. For management purposes, the service provider may need or want to know the currently active leaf LSRs for a channel. Various example embodiments for supporting leaf node discovery for multicast trees, by enabling the root node to be informed explicitly whenever a leaf LSR joins or leaves the multicast tree, may obviate the need for the root LSR to periodically transmit P2MP LSP Pings (which are resource intensive, can get lost, and are typically used to troubleshoot data plane problems or discrepancies between the data plane and the control plane).

For example, mLDP-based P2MP LSPs, as indicated above, may be deployed in VPLS multicast applications. Traditionally, in VPLS the BUM (Broadcast, Unlearned Unicast, Multicast) Ethernet traffic is forwarded to all remotes sites of the VPLS using “ingress replication” in which the ingress router (the originating VPLS site) sends a copy of the packet to each of the remote sites. VPLS Multicast described in RFC 7117 provides a mechanism for setting up a multicast tree between the VPLS sites and then forwarding BUM traffic on that multicast tree without using ingress replication. This tree may be an mLDP-signaled MP LSP. Before a VPLS site sends the BUM traffic over a MP LSP, the VPLS site typically needs to know whether the MP LSP is operational to all remote sites (i.e., that there is no partial failure in the multicast tree which isolates one or more remote sites). It is noted that, while a VPLS service can be set up using Border Gateway Protocol (BGP) Auto Discovery (BGP-AD), where each site is aware of the remote sites, there is no guarantee that all remote sites are successfully connected to the MP LSP. If a remote site is not connected to the multicast tree, then the VPLS site could send BUM traffic to an isolated site using ingress replication. Various example embodiments for supporting leaf node discovery for multicast trees, by enabling the root node to be informed explicitly whenever a leaf LSR joins or leaves the multicast tree, may obviate the need for the root LSR to periodically transmit P2MP LSP Pings (which are resource intensive, can get lost, and are typically used to troubleshoot data plane problems or discrepancies between the data plane and the control plane).

For example, mLDP-based P2MP LSPs, as indicated above, may be deployed for aggregation of applications on MP LSPs. Two types of applications that use an mLDP-based MP LSP include root-initiated applications and leaf-initiated applications. Here, the term “initiated” refers to the signaling model of the application that uses the mLDP-based MP LSP. In general, a root-initiated application originates application specific states from the root LSR and distributes those states to the leaf LSRs through application-specific control plane techniques and then the leaf LSRs send mLDP JOINs towards the root LSR such that, in a root-initiated application, the root LSR is aware of the leaf LSRs. Examples of root-initiated applications include VPLS Multicast using BGP-AD (as described in the RFC 7117, which is entitled “Multicast in VPLS” and which also may be referred to as VPLS-MCAST), IP Multicast VPNs (as described in RFC 6513, which is entitled “Multicast in MPLS/BGP IP VPNs), and P2MP pseudowires (as described in the document entitled “Signaling Root-Initiated Point-to-Multipoint Pseudowire using LDP”), among others. In general, in a leaf-initiated application, there is no application specific coordination between the root LSR and the leaf LSRs; rather, a leaf-initiated application will trigger the leaf LSR to join the MP LSP, such that root LSR of the MP LSP is agnostic of the leaf LSRs (which may cause limitations for aggregation of leaf-initiated applications using mLDP-based MP LSPs). Examples of leaf-initiated applications include statically configured mLDP LSPs, in-band signaling of mLDP LSPs (as described in RFC 6826 and RFC 7438), and VPLS Multicast (as described in VPLS-MCAST) that does not use BGP-AD (in which case a VPLS PE router may be statically provisioned as a leaf node or may send an mLDP JOIN), among others. An example of the limitations for aggregation of leaf-initiated applications using mLDP-based MP LSPs follows for VPLS Multicast. In VPLS Multicast, when setting up an Inclusive P-Multicast Tunnel (e.g., per Section 3.1 in VPLS-MCAST, which indicates that it is a shared tree that can be used by multiple VPLS instances), BGP-AD may be used for VPLS membership auto-discovery. The mLDP MP LSP will be set up when receiving auto-discovery routes through BGP-AD; however, the root LSR will only know the mLDP LSP leaf LSR information which is triggered by the specific BGP-AD mechanism. So (1) if an mLDP-based MP LSP-A (e.g., set up by static configuration or in-band signaling, rather than by BGP-AD) already exists on the root LSR and (2) the LSP-A has the same leaf LSRs as an MP LSP set up using VPLS multicast based on BGP-AD, (3) but the root LSR does not know the leaf LSR information of mLDP-based MP LSP-A, then (4) the root LSR will set up another mLDP-based LSP-B triggered by BGP-AD with same root and leaf LSRs. This causes duplication of mLDP MP LSPs to the same set of leaf LSRs, which is a waste of resources in the network. It is not necessary to set up two non-TE MP LSPs with the same root and leaf LSRs at the same time in one network. This means that, generally, VPLS-MCAST can only aggregate mLDP MP LSPs triggered by its own BGP-AD mechanism and, thus, that cross-application aggregation typically generally is not possible. Various example embodiments for supporting leaf node discovery for multicast trees, by enabling the root node to be informed explicitly whenever a leaf LSR joins or leaves the multicast tree, provide a generic mechanism which enables mLDP to discover leaf nodes of an MP LSP in a manner that is independent of the applications that use the MP LSP (which may thereby prevent duplication of mLDP MP LSPs and, thus, conserve network resources).

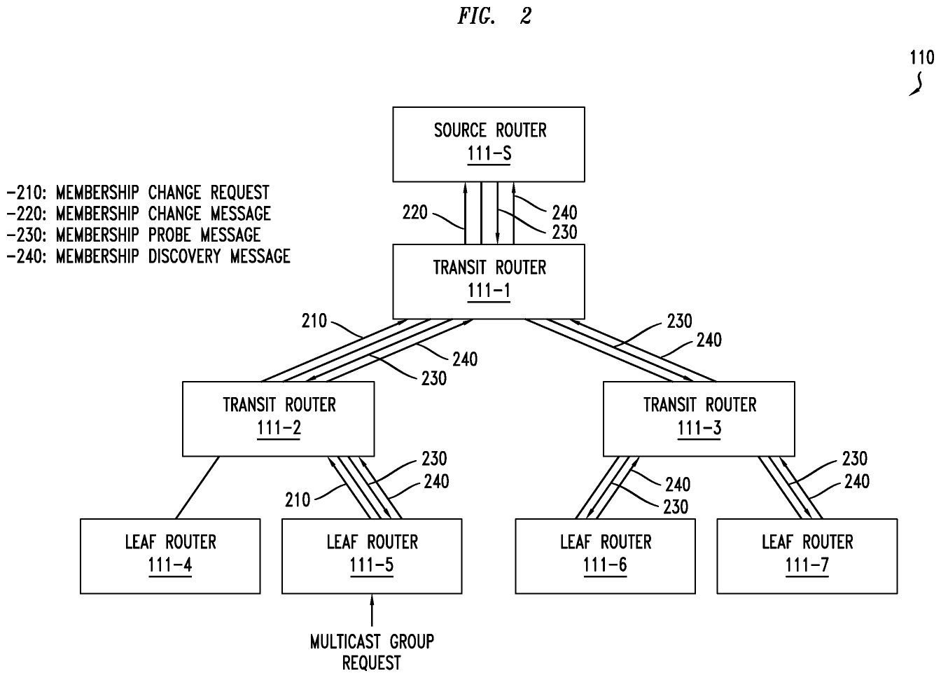

The packet delivery network 110, as discussed above, may be configured to support leaf node discovery within various contexts, thereby enabling efficient, reliable, and scalable leaf node discovery in various contexts. For example, the packet delivery network 110 may be configured to support leaf node discovery for various types of multicast (e.g., IP multicast, MPLS multicast, or the like), for various multicast control protocols (e.g., PIM, mLDP, or the like), for various types of multicast trees (e.g., P2MP, MP2MP, or the like), or the like, as well as various combinations thereof. The operation of packet delivery network 110 in supporting various example embodiments of leaf node discovery may be further understood by way of reference to FIG. 2.

FIG. 2 depicts an example embodiment of leaf node discovery for a multicast tree within the packet delivery network of the communication system of FIG. 1.

In the example of FIG. 2, for purposes of clarity, only relevant portions of the communication system 100 of FIG. 1 are illustrated.

In the example of FIG. 2, it is assumed that the packet delivery network 110 is using MPLS multicast. In the example of FIG. 2, it is further assumed the packet delivery network 110 is currently supporting a multicast tree in the form of a P2MP LSP (denoted as P2MP LSP (S, 3), which is the multicast tree associated with the multicast group (S, G3) of Flow 3 of FIG. 1) that includes leaf routers 111-6 and 111-7 and, thus, that the root node (namely, source router 111-S) has already used leaf node discovery to populate LNDB 113 with leaf membership information for the P2MP LSP (S, 3) (namely, leaf node membership information for the P2MP LSP (S, 3) will indicate that leaf routers 111-6 and 111-7 are the only leaf nodes for P2MP LSP (S, 3)).

In the example of FIG. 2, it is further assumed that an application associated with leaf router 111-5 is requesting to join the multicast group (S, G3) supported by the multicast tree P2MP LSP (S, 3).

The leaf router 111-5 receives a request to join the multicast group. In the example of FIG. 2, the request to join the multicast group may be an IGMP JOIN for (S, G3). The request to join the multicast group is denoted as MULTICAST GROUP REQUEST in FIG. 2.

The leaf router 111-5, based on the request to join the multicast group, maps the multicast group to the multicast tree and sends a membership change request upstream toward transit router 111-2. In the example of FIG. 2, the leaf router 111-5 may map (S, G3) to the P2MP LSP (S, 3) and the membership change request may be an mLDP JOIN for P2MP LSP (S, 3). The membership change request is denoted as MEMBERSHIP CHANGE REQUEST 210 in FIG. 2.

The transit router 111-2 receives a request for a membership change for a leaf node of a multicast tree. In the example of FIG. 2, as indicated above, this is the mLDP JOIN for P2MP LSP (S, 3) that is received by transit router 111-2 from the leaf router 111-5. This is denoted as MEMBERSHIP CHANGE REQUEST 210 in FIG. 2. It will be appreciated that, although primarily presented with respect to an embodiment in which the membership change for a leaf node of a multicast tree that triggers leaf node discovery is a request by a leaf node to join the multicast tree, the membership change for a leaf node of a multicast tree that triggers leaf node discovery also may be a request by a leaf node to leave the multicast tree (e.g., an mLDP PRUNE message or other suitable request by a leaf node to leave the multicast tree).

The transit router 111-2, based on receipt of a request for a membership change for a leaf node of a multicast tree, determines whether a condition is satisfied for triggering leaf node discovery. The condition, when the request for the membership change for the leaf node of the multicast tree is a request to join the multicast tree, may be receipt of the request to join the multicast tree and a determination that a state of the multicast tree exists at the transit router 111-2 when the request to join the multicast tree is received. If the condition is not satisfied, then the request for the membership change for the leaf node of the multicast tree is forwarded upstream; whereas, if the condition is satisfied, then leaf node discovery is initiated. In either case, the state information for the multicast tree is updated at the transit router 111-2 (namely, forwarding state to leaf router 111-5 for P2MP LSP (S, 3) is installed at transit router 111-2). In the example of FIG. 2, since there is no state for P2MP LSP (S, 3) at transit router 111-2 when the request for the membership change was received, leaf node discovery is not initiated, but, rather, the request for the membership change for the leaf node of the multicast tree is forwarded upstream by transit router 111-2 to transit router 111-1. This is again denoted as MEMBERSHIP CHANGE REQUEST 210 in FIG. 2. It will be appreciated that, although primarily presented with respect to an embodiment in which the condition is based on receipt of a membership change that is a request by a leaf node to join the multicast tree, the condition may be based on receipt of a membership change that is a request by a leaf node to leave the multicast tree (e.g., the condition, when the request for the membership change for the leaf node of the multicast tree is a request to leave the multicast tree, may be receipt of the request to leave the multicast tree and a determination that at least one downstream stream is active from the transit router for the multicast tree when the request to leave the multicast tree is received). It will be appreciated that, although primarily presented with respect to an embodiment in which the condition is based on receipt of a membership change, detection of other types of conditions at a transit router (e.g., conditions that are not based on indications of leaf membership changes at the transit router) also may trigger leaf node discovery (e.g., loss of a multicast control plane session to a downstream peer may trigger membership change messages for each of the multicast trees associated with the multicast control plane session).

The transit router 111-1 receives the request for the membership change for the leaf node of a multicast tree. In the example of FIG. 2, as indicated above, this is the mLDP JOIN for P2MP LSP (S, 3) that is received by transit router 111-1 from the transit router 111-2. This is again denoted as MEMBERSHIP CHANGE REQUEST 210 in FIG. 2.

The transit router 111-1, based on receipt of a request for a membership change for a leaf node of a multicast tree, determines whether a condition is satisfied for triggering leaf node discovery. As indicated above, the condition, when the request for the membership change for the leaf node of the multicast tree is a request to join the multicast tree, may be receipt of the request to join the multicast tree and a determination that a state of the multicast tree exists at the transit router 111-2. If the condition is not satisfied, then the request for the membership change for the leaf node of the multicast tree is forwarded upstream; whereas, if the condition is satisfied, then leaf node discovery is initiated. In either case, the state information for the multicast tree is updated at the transit router 111-1 (namely, forwarding state to transit router 111-2 for P2MP LSP (S, 3) is installed at transit router 111-1). In the example of FIG. 2, since there is state for P2MP LSP (S, 3) at transit router 111-1 when the request for the membership change is received, leaf node discovery is initiated. The transit router 111-1, rather than forwarding the request for the membership change for the leaf node of the multicast tree upstream toward source router 111-S, sends a membership change message upstream toward source router 111-S based on detection of the condition. The membership change message, as illustrated in FIG. 2, is sent in-band along the upstream path of the multicast tree until reaching source router 111-S (which, the example of FIG. 2, turns out to be the immediate upstream hop on the multicast tree). This is denoted as MEMBERSHIP CHANGE MESSAGE 220.

The source router 111-S receives the membership change message. The source router 111-S, responsive to the membership change message, initiates a leaf node discovery process for discovering the leaf nodes of the multicast tree. The leaf node discovery process, as discussed further below, includes sending membership probe messages to the leaf nodes of the multicast tree, receiving associated membership discovery messages from the leaf nodes of the multicast tree, and updating leaf node information of the multicast tree based on leaf node information in the membership discovery messages from the leaf nodes of the multicast tree.

The source router 111-S, responsive to the membership change message, sends a membership probe message. The membership probe message is indicative of a request by the source router 111-S for the leaf nodes of the multicast tree to respond with indications of being members of the multicast tree. The membership probe message is sent in-band along the downstream path of the multicast tree toward the downstream transit router 111-1 and is replicated and forwarded in-band along the downstream path of the multicast tree to subsequent downstream transit routers 111 (illustratively, replicated by and forwarded from transit router 111-1 to transit routers 111-1 and 111-2) to reach the leaf nodes of the multicast tree (illustratively, leaf nodes 111-5, 111-6, and 111-7, since leaf nodes 111-6 and 111-7 were previously members of the multicast tree and leaf node 111-5 recently became a member of the multicast tree). This is denoted as MEMBERSHIP PROBE MESSAGE 230.

The leaf routers 111-5-111-7 receive the respective membership probe messages. The leaf routers 111-5-111-7, responsive to the respective membership probe messages, send respective membership discovery messages intended for delivery to the source router 111-S. The membership discovery messages sent by the leaf routers 111-5-111-7 include leaf membership information of the leaf routers 111-5-111-7 for the multicast tree, respectively. The membership discovery messages may be sent in-band along the upstream path of the multicast tree toward the upstream transit routers 111-2 (for leaf router 111-5) and 111-3 (for leaf routers 111-6 and 111-7) and are forwarded in-band along the upstream path of the multicast tree to subsequent upstream transit routers 111 (illustratively, transit router 111-1) to reach the root of the multicast tree (illustratively, source router 111-S). This is denoted as MEMBERSHIP DISCOVERY MESSAGES 240.

The source router 111-S receives the membership discovery messages from the leaf routers 111-5-111-7. The source router 111-S, responsive to the membership discovery messages, updates the leaf node information for the multicast tree. The source router 111-S may update the leaf node information for the multicast tree by storing the leaf node membership of the multicast tree in the LNDB 113. In the example of FIG. 2, since leaf router 111-5 has now joined the multicast tree, the leaf node membership of the multicast tree now includes leaf routers 111-5, 111-6, and 111-7. It is noted that use of in-band signaling for the leaf node discovery process (namely, for the MEMBERSHIP PROBE MESSAGES 230 and the MEMBERSHIP DISCOVERY MESSAGES 240 ensures that the leaf node discovery messages reach the leaf nodes of the multicast tree even where the source router 111-S that triggered the leaf node discovery does not have accurate multicast tree membership information in the LNDB 113 (in this example, source router 111-S only becomes aware that leaf router 111-5 is now a member of the multicast tree due to the leaf node discovery process).

It will be appreciated that, although primarily presented with respect to specific embodiments in which specific messages are sent responsive to specific conditions, various other embodiments also may be supported.

In at least some embodiments, for example, to prevent flooding of membership change messages within the packet delivery network 110, a transit router may be configured to suppress (e.g., prevent or delay) subsequent membership change messages from being sent toward the root router of a multicast tree after the transit router has already sent a membership change message for that multicast tree. The suppression of subsequent membership change messages may be based on a membership change suppression condition, such as expiration of a membership change suppression timer (e.g., a subsequent membership change message is delayed, before being sent toward the root of the multicast tree, until the membership change suppression timer expires), receipt of a membership probe message from the root of the multicast tree (e.g., a subsequent membership change message is prevented from being sent toward the root of the multicast tree until a membership probe message is received from the root of the multicast tree, at which point the subsequent membership change message may be discarded as the membership probe message will trigger discovery of the subsequent membership change anyway), or the like, as well as various combinations thereof. It will be appreciated that such embodiments may be useful under various conditions (e.g., where prunes and joins are frequent (e.g., IP-TV case) or the like).

In at least some embodiments, for example, to prevent flooding of membership probe messages and associated membership discovery messages within the packet delivery network 110, a root router may be configured to suppress (e.g., prevent or delay) subsequent membership probe messages from being sent toward the leaves of a multicast tree after the root router has already sent a membership probe message for that multicast tree. The suppression of subsequent membership probe messages may be based on a membership probe suppression condition, such as expiration of a membership probe suppression timer (e.g., a subsequent membership change probe is delayed, before being sent toward the leaves of the multicast tree, until the membership probe suppression timer expires) or other suitable conditions. It will be appreciated that such embodiments may be useful under various conditions (e.g., where prunes and joins are frequent (e.g., IP-TV case) or the like).

In at least some embodiments, the root router may be configured to, after leaf node discovery for a multicast tree is complete, initiate a process for verifying the results of the leaf node discovery (e.g., a process for checking reachability of the leaf routers in the data plane, a process for verifying that there are not any discrepancies between the control plane and the data plane, or the like, as well as various combinations thereof).

It will be appreciated that the various embodiments presented with respect to FIG. 2 may be adapted for use for leaf node discovery for other types of multicast, other multicast control protocols, other types of multicast trees, or the like, as well as various combinations thereof.

Various example embodiments for supporting leaf node discovery for multicast trees may be provided for various types of multicast (e.g., IP multicast, MPLS multicast, or the like), for various multicast control protocols (e.g., PIM, mLDP, or the like), and for various types of multicast trees (e.g., P2MP, MP2MP, or the like); however, for purposes of clarity, various example embodiments for supporting leaf node discovery for multicast trees are further presented herein within the context of a packet delivery network using mLDP for management of P2MP LSPs based on MPLS multicast (e.g., the example of FIG. 2 provided above, as well as various embodiments discussed further below that are related to supporting various messages and operations of leaf node discovery).

Various example embodiments for leaf node discovery may support leaf node discovery using various message types, including Membership Change Status Messages, Membership Probe Status Messages, and Membership Discovery Status Messages. In at least some embodiments, such messages may be transported using LDP Messages. In at least some embodiments, such messages may be provided using corresponding LDP MP Membership Status Codes encoded within LDP MP Status Value elements included within LDP MP Status TLVs that are carried within LDP Notification Messages. For example, a Membership Change Status Message may be provided using a Membership Change Status Code, a Membership Probe Status Message may be provided using a Membership Probe Status Code, and a Membership Discovery Status Message may be provided using a Membership Discovery Status Code. The use of such LDP MP Membership Status Codes for leaf node discovery for multicast trees may be further understood by considering the formats of LDP MP Status Value elements, LDP MP Status TLVs, and LDP Notification Messages.

The format of the LDP Notification Message, which may be used to transport LDP MP Status TLVs including LDP MP Status Value elements for performing leaf node discovery, follows:

The LDP Notification Message, as indicated above, includes various fields. The usage of the fields is described in RFC 6823. It is noted that the LDP MP Status TLV field indicates status information associated with the MP LSP identified in the LDP MP FEC TLV field (i.e., the LSP for which the Membership Status is notified). The LDP MP Status TLV field, as discussed further below, may be configured to support leaf node discovery for multicast trees by supporting transport of message types used for leaf node discovery (namely, Membership Change Status Messages, Membership Probe Status Messages, and Membership Discovery Status Messages).

The format of the LDP MP Status TLV, which may be used to transport LDP MP Status Value elements for performing leaf node discovery, follows:

The LDP MP Status TLV, as indicated above, includes various fields, including an LDP MP Status Type field, a LDP MP Status Length field, and an LDP MP Status Value field. The usage of the fields is described in Section 5.1 of RFC 6823. The LDP MP Status Type field includes an LDP MP Status Type value (illustratively, 0x096F). The LDP MP Status Length field indicates the length of the LDP MP Status Value field in octets. The LDP MP Status Value field may include one or more LDP MP Status Value elements.

The format of the LDP MP Status Value elements, which may be used to encode LDP MP Membership Status Codes for performing leaf node discovery, follows:

The LDP MP Status Value element, as indicated above, includes various fields, including an LDP MP Status Value Element Type field, a LDP MP Status Value Element Length field, and an LDP MP Status Value Element Value field. The typical usage of the fields is described in Section 5.1 of RFC 6823. The LDP MP Status Value Element Type field includes the type of the LDP MP Status Value Element (which, in leaf node discovery, may be used to indicate which of the LDP MP Membership Status Codes is encoded within the LDP MP Status Value Element). The LDP MP Status Value Element Length field indicates the length of the LDP MP Status Value Element Value field in octets. The LDP MP Status Value Element Value field includes a string of octets to be interpreted as specified by the LDP MP Status Value Element Type field (i.e., based on the LDP MP Status Value Element Types that may be used to indicate the LDP MP Membership Status Codes that may be encoded within the LDP MP Status Value Element). In other words, the encoding of the LDP MP Status Value element is different for Membership Change Status Messages (in which case the LDP MP Status Value Element encodes a Membership Change Status Code), Membership Probe Status Messages (in which case the LDP MP Status Value Element encodes a Membership Probe Status Code), and Membership Discovery Status Messages (in which case the LDP MP Status Value Element encodes a Membership Discovery Status Code).

The LDP MP Status Value element, as indicated above, is used to encode the LDP MP Membership Status Codes that provide the Membership Messages used for leaf node discovery (namely, Membership Change Status Code for Membership Change Status Messages, Membership Probe Status Code for Membership Probe Status Messages, and Membership Discovery Status Code for Membership Discovery Status Messages). As discussed further below, the encoding of the LDP MP Status Value element is different for the different Membership Messages used for leaf node discovery.

The Membership Change Status Message, as described herein, is generated by an LSR to signal addition or removal of a downstream LSR for an MP LSP. The Membership Change Status Message may be sent responsive to detection of various conditions. The LSR that originates the Membership Change Status Message sends the Membership Change Status Message to the upstream LSR of the MP LSP. An LSR that receives a Membership Change Status Message forwards the Membership Change Status Message to its upstream LSR of the MP LSP. The Membership Change Status Message is forwarded in this manner until reaching the root LSR. The Membership Change Status Code, which may be used to provide the Membership Change Status Message, may be encoded within the LDP MP Status Value element as follows:

The Membership Change Status Code, as encoded within the LDP MP Status Value element, includes a Type field, a Length field, an Address Type field, an IP Address field, and an LDP Identifier field.

The Type field of the Membership Change Status Code, as encoded within the LDP MP Status Value element, includes a value indicative that the LDP MP Status Value element encodes a Membership Change Status Code. The value of the Type field has yet to be determined (e.g., a value of 10, which may be allocated from the IANA registry, is suggested; however, it will be appreciated that other suitable values may be used).

The Length field of the Membership Change Status Code, as encoded within the LDP MP Status Value element, has a value that is variable. The value is dependent on the type of IP address that is included, as indicated in the Address Type field and encoded within the IP Address field (e.g., the length is 11 octets for a 4-octet IPv4 address or 23 octets for a 16-octet IPv6 address).

The Address Type field of the Membership Change Status Code, as encoded within the LDP MP Status Value element, indicates the type of IP address included in the IP Address field. For an IPv4 address, the Address Type field may have a Type value of “1” (indicative that a 4-octet IPv4 address is included in the IP Address field). For an IPv6 address, the Address Type field may have a Type value of “2” (indicative that a 16-octet IPv6 address is included in the IP Address field). It will be appreciated that other type values may be used.

The IP Address field of the Membership Change Status Code, as encoded within the LDP MP Status Value element, includes a routable IP address in the LSR that originated the Membership Change Status Code.

The LDP Identifier field of the Membership Change Status Code, as encoded within the LDP MP Status Value element, includes an LDP identifier of the LSR that originated the Membership Change Status Code.

It is noted that an LDP Notification Message including a Membership Change Status Code (which is primarily referred to herein as a Membership Change Status Message or mLDP Membership Change Status Message), also may be referred to more generally as a membership change message (which may be used with various multicast types, types of multicast control protocols, multicast tree types, or the like, as well as various combinations thereof).

The Membership Probe Status Message, as described herein, is generated by the root LSR to discover leaf nodes of an MP LSP. The Membership Probe Status Message may be generated in response to receiving a Membership Change Status Message. An LSR (namely, the root LSR that originates the Membership Probe Status Message and any LSR that receives a Membership Probe Status Message) sends the Membership Probe Status Message to the downstream LSR(s) of the MP LSP. The Membership Probe Status Message is propagated in this manner until reaching the leaf LSRs of the MP LSP. The Membership Probe Status Code, which may be used to provide the Membership Probe Status Message, may be encoded within the LDP MP Status Value element as follows:

The Membership Probe Status Code, as encoded within the LDP MP Status Value element, includes a Type field, a Length field, and a RESERVED field.

The Type field of the Membership Probe Status Code, as encoded within the LDP MP Status Value element, includes a value indicative that the LDP MP Status Value element encodes a Membership Probe Status Code. The value of the Type field has yet to be determined (e.g., a value of 11, which may be allocated from the IANA registry, is suggested; however, it will be appreciated that other suitable values may be used).

The Length field of the Membership Probe Status Code, as encoded within the LDP MP Status Value element, has a value of 1 (the size bit used in the RESERVED field).

The RESERVED field of the Membership Probe Status Code, as encoded within the LDP MP Status Value element, has a value of 0. This field is ignored by the receiver.

It is noted that an LDP Notification Message including a Membership Probe Status Code (which is primarily referred to herein as a Membership Probe Status Message or mLDP Membership Probe Status Message), also may be referred to more generally as a membership probe status message or membership probe message (which may be used with various multicast types, types of multicast control protocols, multicast tree types, or the like, as well as various combinations thereof).

The Membership Discovery Status Message, as described herein, is generated by a leaf LSR (which may be a leaf LSR or a bud LSR operating as a leaf LSR for that multicast tree) to signal its membership status on an MP LSP. The Membership Discovery Status Message may be sent responsive to receipt of a Membership Probe Status Message from the root LSR. The LSR that originates the Membership Discovery Status Message (namely, a leaf LSR) sends the Membership Discovery Status Message to the upstream LSR of the MP LSP. An LSR that receives a Membership Discovery Status Message forwards the Membership Discovery Status Message to its upstream LSR of the MP LSP. The Membership Discovery Status Message is forwarded in this manner until reaching the root LSR. The Membership Discovery Status Code, which may be used to provide the Membership Discovery Status Message, may be encoded within the LDP MP Status Value element as follows:

The Membership Discovery Status Code, as encoded within the LDP MP Status Value element, includes a Type field, a Length field, an Address Type field, an IP Address field, an LDP Identifier field, a Flags field, and a RESERVED field.

The Type field of the Membership Discovery Status Code, as encoded within the LDP MP Status Value element, includes a value indicative that the LDP MP Status Value element encodes a Membership Discovery Status Code. The value of the Type field has yet to be determined (e.g., a value of 12, which may be allocated from the IANA registry, is suggested; however, it will be appreciated that other suitable values may be used).

The Length field of the Membership Discovery Status Code, as encoded within the LDP MP Status Value element, has a value that is variable. The value is dependent on the type of IP address that is included, as indicated in the Address Type field and encoded within the IP Address field (e.g., the length is 13 octets for a 4-octet IPv4 address or 25 octets for a 16-octet IPv6 address).

The Address Type field of the Membership Discovery Status Code, as encoded within the LDP MP Status Value element, indicates the type of IP address included in the IP Address field. For an IPv4 address, the Address Type field may have a Type value of “1” (indicative that a 4-octet IPv4 address is included in the IP Address field). For an IPv6 address, the Address Type field may have a Type value of “2” (indicative that a 16-octet IPv6 address is included in the IP Address field). It will be appreciated that other type values may be used.

The IP Address field of the Membership Discovery Status Code, as encoded within the LDP MP Status Value element, includes a routable IP address in the leaf LSR (which, again, may be a leaf LSR or a bud LSR operating as a leaf LSR for that multicast tree) that originated the Membership Discovery Status Code.

The LDP Identifier field of the Membership Discovery Status Code, as encoded within the LDP MP Status Value element, includes an LDP identifier of the leaf (which, again, may be a leaf LSR or a bud LSR operating as a leaf LSR for that multicast tree) LSR that originated the Membership Discovery Status Code.

The Flags field of the Membership Discovery Status Code, as encoded within the LDP MP Status Value element, is a 1-octet field which may be used to encode various flags which may be used for various purposes. The Flags field may be configured such that bit 0 (LSB) of the Flags field is defined as an L Flag. The L Flag may be used to indicate whether the LSR that originated the Membership Discovery Status Code is a leaf LSR or a bud LSR (e.g., one value (such as “1”) may be used to indicate a leaf LSR and another value (such as “0”) may be used to indicate a bud LSR). It is noted that the other bits of the Flags field may be set to zero when originated and ignored when received.

The RESERVED field of the Membership Discovery Status Code, as encoded within the LDP MP Status Value element, has a value of 0. This field is ignored by the receiver.

It is noted that an LDP Notification Message including a Membership Discovery Status Code (which is primarily referred to herein as a Membership Discovery Status Message or mLDP Membership Discovery Status Message), also may be referred to more generally as a membership discovery status message or a membership discovery message (which may be used with various multicast types, types of multicast control protocols, multicast tree types, or the like, as well as various combinations thereof).

Various example embodiments for leaf node discovery may support leaf node discovery using various leaf node discovery processes. The leaf node discovery processes, as indicated above, may utilize various message types, including Membership Change Status Messages, Membership Probe Status Messages, and Membership Discovery Status Messages. The various leaf node discovery processes may be further understood by considering operation of leaf node discovery processes for a P2MP LSP which is identified by a P2MP FEC Element in LDP (in which case the various message types may be specified using P2MP Notification Messages, such as P2MP Notification <X, Y, S>: a Notification Message with a FEC TLV with a single P2MP FEC Element <X, Y> and MP Status TLV with MP Status Type S).

The leaf node discovery process is triggered by an LSR that sends an LDP Notification Message with a Membership Change Status Code.

An LSR may originate an LDP Notification Message with a Membership Change Status Code on receipt of a Label Mapping Message or a Label Withdraw Message for an MP-LSP, provided that the received Label Mapping Message or Label Withdraw Message creates certain conditions at the LSR (where, as discussed further below, the conditions are different for Label Mapping Messages and Label Withdraw Messages).

For example, an LSR (denoted below as transit LSR Z) may originate an LDP Notification Message with a Membership Change Status Code on receipt of a Label Mapping Message for an MP-LSP, provided that the received Label Mapping Message creates certain conditions at the LSR: (1) the transit LSR Z received a P2MP Label Mapping <X, Y, L> from LSR T, (2) the transit LSR Z resolved LSR T as the downstream LSR for the P2MP LSP <X, Y>, (3) the transit LSR Z updated the forwarding state of P2MP LSP <X, Y> with label L on interface(s) associated with LSR T, and (4) the transit LSR Z determined that LSR T is not the first downstream LSR for the P2MP LSP <X, Y> (since, if transit LSR Z was not a transit LSR for P2MP LSP <X, Y> prior to receipt of this Label Mapping Message, then transit LSR Z had not sent any Label Mapping Message to the upstream LSR U of the P2MP LSP <X, Y>). The transit LSR Z, based on a determination that the above conditions are satisfied, sends a P2MP Notification <X, Y, S> where S is the Membership Change Status Code. The Membership Change Status Code is encoded such that the IP Address Field includes a routable IP address in transit LSR Z (and the Address Type field is encoded accordingly) and such that the LDP Identifier field includes the LDP identifier of transit LSR Z. The P2MP Notification <X, Y, S> is sent to the upstream LSR U of the P2MP LSP <X, Y>.

For example, an LSR (denoted below as transit LSR Z) may originate an LDP Notification Message with a Membership Change Status Code on receipt of a Label Withdraw Message for an MP-LSP, provided that the received Label Withdraw Message creates certain conditions at the LSR: (1) the transit LSR Z received a P2MP Label Withdraw <X, Y, L> from LSR T, (2) the transit LSR determines that Label L is programmed in the forwarding state of P2MP LSP <X, Y> and updates the forwarding state of P2MP LSP >X, Y> by removing label L from interface(s) associated with LSR T, (3) the transit LSR Z determined that LSR T is not the last downstream LSR for the P2MP LSP <X, Y> (since, if transit LSR Z is no longer a transit LSR for P2MP LSP <X, Y> upon receipt of this Label Withdraw Message, then transit LSR Z would anyway send a Label Withdraw Message to the upstream LSR U of the P2MP LSP <X, Y>). The transit LSR Z, based on a determination that the above conditions are satisfied, sends a P2MP Notification <X, Y, S> where S is a Membership Change Status Code. The Membership Change Status Code is encoded such that the IP Address Field includes a routable IP address in transit LSR Z (and the Address Type field is encoded accordingly) and such that the LDP Identifier field includes the LDP identifier of transit LSR Z. The P2MP Notification <X, Y, S> is sent to the upstream LSR U of the P2MP LSP <X, Y>.

It is noted that, in the case of a MP2MP LSP, there will be multiple upstream LSR Us, in which case the Membership Change Status Code is sent to each of the upstream LSR Us.

An LSR may receive an LDP Notification Message with a Membership Change Status Code from a downstream LSR for an MP LSP. An LSR Z that receives a P2MP Notification <X, Y, S> from LSR T, where S is a Membership Change Status Code, may process the P2MP Notification <X, Y, S> as follows. The LSR Z determines if the LSR T is programmed as downstream in the forwarding state of P2MP LSP <X, Y>. If the LSR T is not programmed as downstream in the forwarding state of P2MP LSP <X, Y>, then the LSR Z takes no further action with respect to the P2MP Notification <X, Y, S>. If the LSR T is programmed as downstream in the forwarding state of P2MP LSP <X, Y>, then the LSR Z determines whether it is the root LSR of the P2MP LSP <X, Y> (i.e., whether X=Z). If LSR Z determines that it is not the root LSR of the P2MP LSP <X, Y> (which means that it is a transit node of the P2MP LSP <X, Y>), then LSR Z forwards the P2MP Notification <X, Y, S> to upstream LSR U of the P2MP LSP <X, Y>. If LSR Z determines that it is the root LSR of the P2MP LSP <X, Y>, then it originates a P2MP Notification <X, Y, S> where S is the Membership Probe Status Code. It is noted that, in the case of a MP2MP LSP, there will be multiple upstream LSR Us, in which case the Membership Change Status Code is sent to each of the upstream LSR Us when the LSR Z is a transit LSR rather than a root LSR.

A root LSR may receive an LDP Notification Message with a Membership Change Status Code from a downstream LSR for an MP LSP and send an LDP Notification Message with a Membership Probe Status Code for the MP LSP. A root LSR Z that receives a P2MP Notification <X, Y, S> (where S is a Membership Change Status Code), based on a determination that it is the root LSR of the P2MP LSP <X, Y>, may send a P2MP Notification <X, Y, S> (where S is a Membership Probe Status Code) to all of its downstream LSRs that are programmed in the forwarding state of P2MP LSP <X, Y>. It is noted that, in the case of a MP2MP LSP, each leaf LSR is also the root LSR such that, upon receipt of the Membership Change Status Code, only one of the root LSRs (referred to as the designated root LSR, which may be defined in various ways, such as the LSR having the highest LDP-ID from the “current” leaf node database) may send a P2MP Notification <X, Y, S> (where S is a Membership Probe Status Code) to all of its downstream LSRs that are programmed in the forwarding state of P2MP LSP <X, Y>.

An LSR may receive an LDP Notification Message with a Membership Probe Status Code from an upstream LSR for an MP LSP. An LSR Z that receives a P2MP Notification <X, Y, S> from LSR T, where S is a Membership Probe Status Code, may process the P2MP Notification <X, Y, S> as follows. The LSR Z determines whether it has forwarding state on P2MP LSP <X, Y> to other downstream LSRs. If the LSR Z determines that it does have forwarding state on P2MP LSP <X, Y> to at least one downstream LSRs, then the LSR Z forwards the P2MP Notification <X, Y, S> to each of the downstream LSRs for which it has forwarding state on P2MP LSP <X, Y>. If the LSR Z determines that it does not have forwarding state on P2MP LSP <X, Y> to other downstream LSRs, then the LSR Z determines whether it is a leaf LSR (which, again, may be a bud LSR operating as a leaf LSR for that multicast tree) for P2MP LSP <X, Y>. If the LSR Z determines that it is not a leaf LSR for P2MP LSP <X,Y>, then LSR Z takes no further action with respect to the P2MP Notification <X, Y, S>. If the LSR Z determines that it is a leaf LSR for the P2MP LSP <X, Y>, then it originates a P2MP Notification <X, Y, S> where S is the Membership Discovery Status Code.

A leaf LSR (which, again, may be a bud LSR operating as a leaf LSR for that multicast tree) may receive an LDP Notification Message with a Membership Probe Status Code from an upstream LSR for an MP LSP and send an LDP Notification Message with a Membership Discovery Status Code for the MP LSP. A leaf LSR Z that receives a P2MP Notification <X, Y, S> (where S is a Membership Probe Status Code) may send a P2MP Notification <X, Y, S> (where S is a Membership Discovery Status Code) to the upstream LSR U of the P2MP LSP <X, Y>. The Membership Discovery Status Code is encoded such that the IP Address Field includes a routable IP address of the leaf LSR Z (and the Address Type field is encoded accordingly) and such that the LDP Identifier field includes the LDP identifier of the leaf LSR Z. The Membership Discovery Status Code is also encoded to indicate whether the LSR Z is a leaf LSR or a bud LSR (e.g., the L-Flag in the Membership Discovery Status Code is set (e.g., equal to “1”) if the LSR Z is a leaf LSR or is unset (e.g., equal to “0”) if the LSR Z is a bud LSR). The P2MP Notification <X, Y, S> is sent to the upstream LSR U of the P2MP LSP <X, Y>. It is noted that, in the case of a MP2MP LSP, since there will be multiple upstream LSR Us, the Membership Discovery Status Code is sent to each of the upstream LSR Us.

An LSR may receive an LDP Notification Message with a Membership Discovery Status Code from a downstream LSR for an MP LSP. An LSR Z that receives a P2MP Notification <X, Y, S> from LSR T, where S is a Membership Discovery Status Code, may process the P2MP Notification <X, Y, S> as follows. The LSR Z determines if the LSR T is programmed as downstream in the forwarding state of P2MP LSP <X, Y>. If the LSR T is not programmed as downstream in the forwarding state of P2MP LSP <X, Y>, then the LSR Z takes no further action with respect to the P2MP Notification <X, Y, S>. If the LSR T is programmed as downstream in the forwarding state of P2MP LSP <X, Y>, then the LSR Z determines whether it is the root LSR of the P2MP LSP <X, Y> (i.e., whether X=Z). If LSR Z determines that it is not the root LSR of the P2MP LSP <X, Y> (which means that it is a transit node of the P2MP LSP <X, Y>), then LSR Z forwards the P2MP Notification <X, Y, S> upstream to upstream LSR U of the P2MP LSP <X, Y>. If LSR Z determines that it is the root LSR of the P2MP LSP <X, Y>, then it updates the leaf node database with information about the leaf LSR that originated the LDP Notification Message with the Membership Discovery Status Code. It is noted that, in the case of a MP2MP LSP, there will be multiple upstream LSR Us, in which case the Membership Discovery Status Code is sent to each of the upstream LSR Us when the LSR Z is a transit LSR rather than a root LSR.

A root LSR may receive an LDP Notification Message with a Membership Discovery Status Code from a downstream LSR for an MP LSP and process the LDP Notification Message with the Membership Discovery Status Code to update the leaf node database with information about the leaf LSR that originated the LDP Notification Message with the Membership Discovery Status Code. A root LSR Z that receives a P2MP Notification <X, Y, S> (where S is a Membership Discovery Status Code), based on a determination that it is a root LSR of the P2MP LSP <X, Y> may update the leaf node database with information about the leaf LSR that originated the P2MP Notification <X, Y, S>.

In at least some embodiments, one or more timers may be used within the context of the leaf node discovery process.

In at least some embodiments, a membership discovery timer (associated with the P2MP LSP <X, Y>) may be used by the root LSR of the P2MP LSP <X, Y> to determine the end of a leaf node discovery process initiated by the root LSR of the P2MP LSP <X, Y> for the P2MP LSP <X, Y>. The root LSR of the P2MP LSP <X, Y> may start the membership discovery timer based on sending of the P2MP Notification <X, Y, S> where S is a Membership Probe Status Code (e.g., after sending the P2MP Notification <X, Y, S>). The root LSR of the P2MP LSP <X, Y>, upon detecting the end of the membership discovery timer for the P2MP LSP <X, Y>, may determine that the leaf node discovery process for the P2MP LSP <X, Y> is complete (e.g., the root LSR assumes that it must have received Membership Discovery Status from all of the leaf LSRs on the P2MP LSP <X, Y>).

In at least some embodiments, a membership change suppression timer (associated with the P2MP LSP <X, Y>) may be used by a transit LSR of the P2MP LSP <X, Y> to prevent multiple Membership Change Status Messages from being propagated toward the root LSR of the P2MP LSP <X, Y>. The transit LSR of the P2MP LSP <X, Y> may start the membership change suppression timer based on sending of the P2MP Notification <X, Y, S> where S is a Membership Change Status Code (e.g., after sending the P2MP Notification <X, Y, S>). The transit LSR of the P2MP LSP <X, Y> may, while the membership change suppression timer is running for P2MP LSP <X, Y>, prevent subsequent Membership Change Status Messages from being propagated toward the root LSR of the P2MP LSP <X, Y>. The initial Membership Change Status Message sent by the transit LSR of the P2MP LSP <X, Y> toward the root LSR of the P2MP LSP <X, Y> will trigger the root LSR of the P2MP LSP <X, Y> to send a Membership Probe Status Message for discovering the leaf LSRs of the P2MP LSP <X, Y>, such that any additional Membership Change Status Message sent by the transit LSR of the P2MP LSP <X, Y> toward the root LSR of the P2MP LSP <X, Y> for the P2MP LSP <X, Y> during this time may be considered to be redundant and, thus, unnecessary. The transit LSR of the P2MP LSP <X, Y> may accumulate Membership Change Status Messages for the P2MP LSP <X, Y> that are prevented from being sent while the membership change suppression timer for the P2MP LSP <X, Y> is running (e.g., generating the Membership Change Status Messages that would have been sent in the absence of the membership change suppression timer and storing these Membership Change Status Messages for use after the membership change suppression timer expires). The transit LSR of the P2MP LSP <X, Y> may stop the membership change suppression timer based on receipt of a Membership Probe Status Message from the root LSR of the P2MP LSP <X, Y>. The membership change suppression timer may be configured to be a period of time which will be or is expected to be sufficient for receipt of the Membership Probe Status Message from the root LSR of the P2MP LSP <X, Y>. The transit LSR of the P2MP LSP <X, Y> may, based on stopping of the membership change suppression timer, send one of the Membership Change Status Messages accumulated for the P2MP LSP <X, Y> while the membership change suppression timer was running, toward the root LSR of the M2MP LSP <X, Y>.

In at least some embodiments, a membership probe suppression timer (associated with the P2MP LSP <X, Y>) may be used by the root LSR of the P2MP LSP <X, Y> to prevent multiple Membership Probe Status Messages from being sent by the root LSR of the P2MP LSP <X, Y> (i.e., to prevent the leaf node discovery process from being executed multiple times in parallel for the same P2MP LSP <X, Y>). The root LSR of the P2MP LSP <X, Y> may start the membership probe suppression timer based on sending of the P2MP Notification <X, Y, S> where S is a Membership Probe Status Code (e.g., after sending the P2MP Notification <X, Y, S>). The root LSR of the P2MP LSP <X, Y> may, while the membership probe suppression timer is running for P2MP LSP <X, Y>, prevent subsequent Membership Probe Status Messages from being propagated by the root LSR of the P2MP LSP <X, Y>. The initial Membership Probe Status Message sent by the root LSR of the P2MP LSP <X, Y> triggers the leaf node discovery for the P2MP LSP <X, Y>, such that any additional Membership Probe Status Messages sent by the root LSR of the P2MP LSP <X, Y> for the P2MP LSP <X, Y> during this time may be considered to be redundant and, thus, unnecessary. The root LSR of the P2MP LSP <X, Y> may accumulate Membership Probe Status Messages for the P2MP LSP <X, Y> that are prevented from being sent while the membership probe suppression timer for the P2MP LSP <X, Y> is running (e.g., generating the Membership Probe Status Messages that would have been sent in the absence of the membership probe suppression timer and storing these Membership Probe Status Messages for use after the membership probe suppression timer expires). The root LSR of the P2MP LSP <X, Y> may stop the membership probe suppression timer based on administrative intervention. The membership probe suppression timer may be configured to be a period of time which will be or is expected to be sufficient for tolerance of the application(s) that use the leaf node database (e.g., how fast VPLS BUM traffic is to be re-based over the multicast tree). The root LSR of the P2MP LSP <X, Y> may, based on stopping of the membership probe suppression timer, send one of the Membership Probe Status Messages accumulated for the M2MP LSP <X, Y> while the membership probe suppression timer was running.

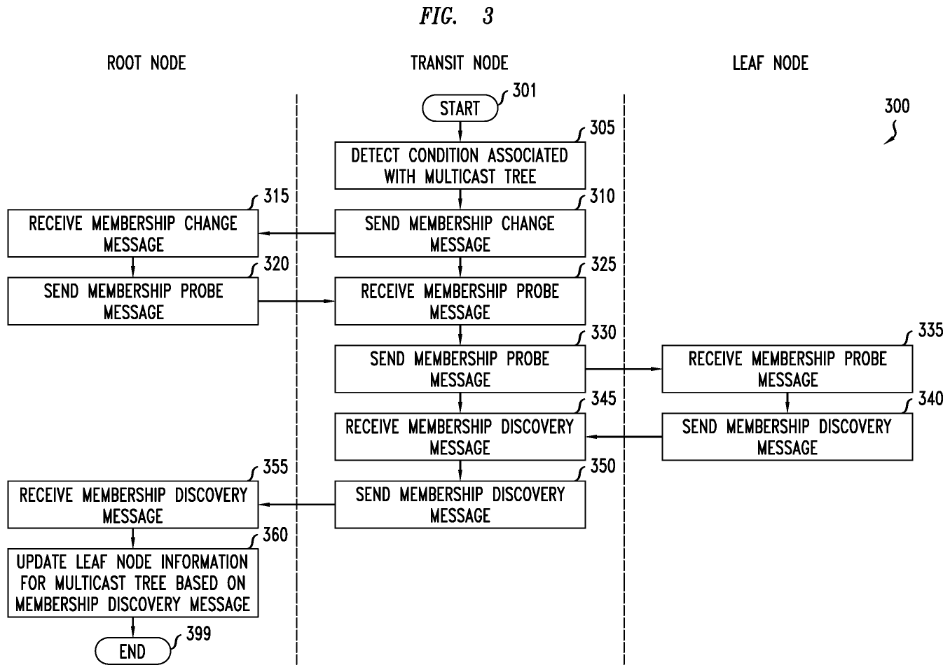

It will be appreciated that, although primarily presented herein within the context of supporting leaf node discovery in a packet delivery network using mLDP for management of P2MP LSPs based on MPLS multicast, various example embodiments for supporting leaf node discovery for multicast trees may be provided within various other contexts (e.g., for various types of multicast, for various multicast control protocols, for various types of multicast trees, or the like, as well as various combinations thereof) and thus, that various context-specific terms (e.g., network element types, message names, timer names, or the like) may be referred to more generally (e.g., as presented with respect to FIG. 3 or using other appropriate terms).

FIG. 3 depicts an example embodiment of a process for leaf node discovery for a multicast tree. It will be appreciated that, of the functions of method 300, a portion of the functions are performed by a root node of the multicast tree, a portion of the functions are performed by a transit node of the multicast tree, and a portion of the functions are performed by a leaf node of the multicast tree. It will be appreciated that the functions performed by the respective node types may be implemented as separate processes running on nodes of those node types, respectively. It will be appreciated that, although presented with respect to functions performed by a single root node, at least a portion of the functions presented as being performed by the root node may be repeated by various other root nodes of the multicast tree. It will be appreciated that, although presented with respect to functions performed by a single transit node, at least a portion of the functions presented as being performed by the transit node may be repeated by various other transit nodes of the multicast tree. It will be appreciated that, although presented with respect to functions performed by a single leaf node, at least a portion of the functions presented as being performed by the leaf node may be repeated by various other leaf nodes of the multicast tree.

At block 301, method 300 begins.

At block 305, the transit node detects a condition associated with multicast tree. The condition may be a condition associated with a request for a membership change for a leaf node of the multicast tree. The condition associated with the request for the membership change for the leaf node of the multicast tree may include receipt of a join message for the multicast tree and a determination that a state of the multicast tree exists at the transit node. The condition associated with the request for the membership change for the leaf node of the multicast tree may include receipt of a prune message for the multicast tree and a determination that at least one downstream stream is active from the transit node for the multicast tree. The condition associated with the multicast tree may include a loss of a multicast control plane session to a downstream peer. It will be appreciated that other conditions may be supported.

At block 310, the transit node sends a membership change message. The membership change message is indicative of a membership change in the multicast tree. The membership change message is sent for delivery to the root node. The membership change message may be sent in-band along the upstream path of the multicast tree using the control plane protocol of the leaf node discovery process (which may be control plane protocol used to signal the multicast tree of a different control plane protocol). It will be appreciated that, although the membership change message may be sent responsive to receipt of an indication that a particular leaf node joined or left the multicast group, the membership change message may not include any leaf membership information (even for the leaf node which may have sent a join or prune message which triggered the membership change message), but, rather, may simply indicate that membership of the multicast tree changed in general. It will be appreciated that the membership change message may traverse one or more other transit nodes (each of which may support receipt and forwarding of the membership change message) on the path of the multicast tree to the root node.

At block 315, the root node receives the membership change message. The membership change message triggers the root node to perform a leaf node discovery process (which is presented with respect to functions 320-360 of FIG. 3).

At block 320, the root node sends a membership probe message. The membership probe message is indicative of a request by the root node for leaf nodes of the multicast tree to respond with indications of being members of the multicast tree. The membership probe message is sent for delivery to each of the leaf nodes of the multicast tree. The membership probe message may be sent in-band along the downstream path of the multicast tree using the control plane protocol of the leaf node discovery process (which may be control plane protocol used to signal the multicast tree of a different control plane protocol). It will be appreciated that the membership probe message may traverse one or more transit nodes (each of which may support receipt and forwarding of the membership probe message) on the path to the leaf nodes.

At block 325, the transit node receives the membership probe message. It will be appreciated that the membership probe message may traverse one or more other transit nodes (each of which may support receipt and forwarding of the membership probe message) on the path to the transit node.

At block 330, the transit node sends the membership probe message. The membership probe message is sent toward leaf nodes of the multicast tree. The membership probe message may be sent in-band along the downstream path of the multicast tree using the control plane protocol of the leaf node discovery process (which may be control plane protocol used to signal the multicast tree of a different control plane protocol). It will be appreciated that the membership probe message may traverse one or more other transit nodes (each of which may support receipt and forwarding of the membership probe message) on the path to the leaf node.

At block 335, the leaf node receives the membership probe message. It will be appreciated that the membership probe message may traverse one or more other transit nodes on the path to the leaf node. It will be appreciated that, although omitted from FIG. 3 for purposes of clarity, the membership probe message also may be received by other leaf nodes of the multicast tree.

At block 340, the leaf node sends a membership discovery message. The leaf node sends the membership discovery message responsive to the membership probe message. The leaf node sends the membership discovery message toward the root node. The membership discovery message includes leaf membership information of the leaf node for the multicast tree. The membership discovery message may be sent in-band along the upstream path of the multicast tree using the control plane protocol of the leaf node discovery process (which may be control plane protocol used to signal the multicast tree of a different control plane protocol). It will be appreciated that the membership discovery message may traverse one or more transit nodes (each of which may support receipt and forwarding of the membership discovery message) on the path to the root node.

At block 345, the transit node receives the membership discovery message. It will be appreciated that the membership discovery message may traverse one or more other transit nodes (each of which may support receipt and forwarding of the membership discovery message) on the path to the transit node.

At block 350, the transit node sends the membership discovery message. The transit node sends the membership discovery message toward the root node. The membership discovery message may be sent in-band along the upstream path of the multicast tree using the control plane protocol of the leaf node discovery process (which may be control plane protocol used to signal the multicast tree of a different control plane protocol). It will be appreciated that the membership discovery message may traverse one or more other transit nodes (each of which may support receipt and forwarding of the membership discovery message) on the path to the root node.

At block 355, the root node receives the membership discovery message. It will be appreciated that, although omitted from FIG. 3 for purposes of clarity, membership discovery messages also may be received from other leaf nodes of the multicast tree.

At block 360, the root node updates the leaf node information for the multicast tree based on the membership discovery message. The root node updates the leaf node information for the multicast tree based on the leaf membership information included in the membership discovery message.

At block 399, method 300 ends.

It will be appreciated that, although primarily presented herein with respect to embodiments for leaf node discovery for multicast trees signaled using leaf-initiated multicast protocols, various embodiments for leaf node discovery may be adapted to support leaf node membership verification for multicast trees signaled using root-initiated multicast protocols (e.g., Point-to-Multipoint (P2MP) Resource Reservation Protocol (P2MP-RSVP) or the like). For example, various embodiments for leaf node discovery may be configured to support leaf node membership verification by supporting triggering of the root node of a multicast tree to send a membership probe message indicative of a request by the root node for leaf nodes of the multicast tree to respond with indications of being members of the multicast tree (e.g., the triggering of the root node to send the membership probe message may be initiated by a system (e.g., periodically, responsive to detection of a condition, or the like), initiated by a system administrator via an administrative tool or system, or the like, as well as various combinations thereof).

Various example embodiments for leaf node discovery may provide various advantages or potential advantages. For example, various example embodiments for leaf node discovery may provide a generic, in-band process for leaf node discovery that is independent of the application contexts that use the multicast trees (e.g., built within mLDP or other suitable multicast control protocols). For example, various example embodiments for leaf node discovery may provide an efficient and accurate process for leaf node discovery (e.g., since the messages traverse the paths and states of the multicast tree in the multicast control plane (e.g., in the LDP control plane or other suitable control plane)). For example, various example embodiments for leaf node discovery may provide a reliable process for leaf node discovery (e.g., where the multicast control protocol is based on a reliable transport protocol (e.g., such as the LDP control plane being based on Transmission Control Protocol (TCP)) so that the messages are sent through reliable channels). For example, various example embodiments for leaf node discovery may provide a leaf node discovery process that is triggered by transit routers, but which is controlled by the root router such that the root router can accurately and reliably obtain leaf node information for leaf nodes of the multicast tree. For example, various embodiments for leaf node discovery may be configured to support leaf node membership verification for multicast trees signaled using root-initiated multicast protocols. Various example embodiments for leaf node discovery may provide various other advantages or potential advantages.

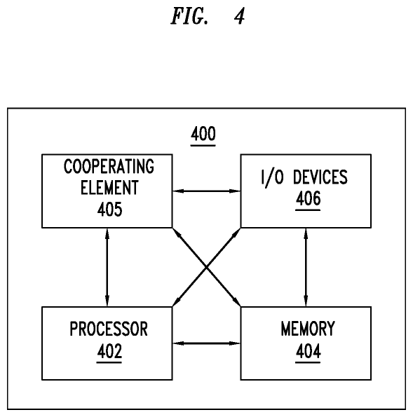

FIG. 4 depicts a high-level block diagram of a computer suitable for use in performing various functions described herein.

The computer 400 includes a processor 402 (e.g., a central processing unit (CPU), a processor having a set of processor cores, a processor core of a processor, or the like) and a memory 404 (e.g., a random access memory (RAM), a read only memory (ROM), or the like). The processor 402 and the memory 404 may be communicatively connected.

The computer 400 also may include a cooperating element 405. The cooperating element 405 may be a hardware device. The cooperating element 405 may be a process that can be loaded into the memory 404 and executed by the processor 402 to implement functions as discussed herein (in which case, for example, the cooperating element 405 (including associated data structures) can be stored on a non-transitory computer-readable storage medium, such as a storage device or other storage element (e.g., a magnetic drive, an optical drive, or the like)).

The computer 400 also may include one or more input/output devices 406. The input/output devices 406 may include one or more of a user input device (e.g., a keyboard, a keypad, a mouse, a microphone, a camera, or the like), a user output device (e.g., a display, a speaker, or the like), one or more network communication devices or elements (e.g., an input port, an output port, a receiver, a transmitter, a transceiver, or the like), one or more storage devices (e.g., a tape drive, a floppy drive, a hard disk drive, a compact disk drive, or the like), or the like, as well as various combinations thereof.

It will be appreciated that computer 400 of FIG. 4 may represent a general architecture and functionality suitable for implementing functional elements described herein, portions of functional elements described herein, or the like, as well as various combinations thereof. For example, computer 400 may provide a general architecture and functionality that is suitable for implementing one or more elements presented herein, such as a router 111, an LNDE 112, or the like.

It will be appreciated that at least some of the functions presented herein may be implemented in software (e.g., via implementation of software on one or more processors, for executing on a general purpose computer (e.g., via execution by one or more processors) so as to provide a special purpose computer, and the like) and/or may be implemented in hardware (e.g., using a general purpose computer, one or more application specific integrated circuits (ASIC), and/or any other hardware equivalents).

It will be appreciated that at least some of the functions presented herein may be implemented within hardware, for example, as circuitry that cooperates with the processor to perform various functions. Portions of the functions/elements described herein may be implemented as a computer program product wherein computer instructions, when processed by a computer, adapt the operation of the computer such that the methods and/or techniques described herein are invoked or otherwise provided. Instructions for invoking the various methods may be stored in fixed or removable media (e.g., non-transitory computer-readable media), transmitted via a data stream in a broadcast or other signal bearing medium, and/or stored within a memory within a computing device operating according to the instructions.

It will be appreciated that the term “or” as used herein refers to a non-exclusive “or” unless otherwise indicated (e.g., use of “or else” or “or in the alternative”).

It will be appreciated that, although various embodiments which incorporate the teachings presented herein have been shown and described in detail herein, those skilled in the art can readily devise many other varied embodiments that still incorporate these teachings.

1-20. (canceled)

21. An apparatus, comprising:
at least one processor; and
at least one memory including computer program code;
wherein the at least one memory and the computer program code are configured to, with the at least one processor, cause the apparatus to at least:
detect, by a transit node of a multicast tree, a condition associated with a request for a membership change for a leaf node of the multicast tree; and
send, by the transit node toward a root node of the multicast tree based on detection of the condition associated with the request for the membership change for the leaf node of the multicast tree, a membership change message indicative of a membership change in the multicast tree.

22. The apparatus of claim 21, wherein the condition associated with the request for the membership change for the leaf node of the multicast tree comprises receipt of a join message for the multicast tree and a determination that a state of the multicast tree exists at the transit node.

23. The apparatus of claim 21, wherein the condition associated with the request for the membership change for the leaf node of the multicast tree comprises receipt of a prune message for the multicast tree and a determination that at least one downstream stream is active from the transit node for the multicast tree.

24. The apparatus of claim 21, wherein the membership change message is sent toward the root node of the multicast tree using in-band signaling based on a multicast tree control protocol.

25. The apparatus of claim 21, wherein the at least one memory and the computer program code are configured to, with the at least one processor, cause the apparatus to at least:
start, by the transit node based on the sending of the membership change message indicative of the membership change in the multicast tree, a membership change suppression timer for the multicast tree;
detect, by the transit node, a second condition associated with a second request for a membership change for a second leaf node of the multicast tree; and
prevent, by the transit node based on the membership change suppression timer, sending of a second membership change message toward the root node.

26. The apparatus of claim 21, wherein the at least one memory and the computer program code are configured to, with the at least one processor, cause the apparatus to at least:
receive, by the transit node from an upstream node of the multicast tree, a membership probe message indicative of a request by the root node for leaf nodes of the multicast tree to respond with indications of being members of the multicast tree; and
send, by the transit node toward a downstream node of the multicast tree, the membership probe message.

27. The apparatus of claim 26, wherein the membership probe message is sent based on a determination that the transit node includes downstream forwarding state for the multicast tree and a determination that the transit node is not a leaf node of the multicast tree.

28. The apparatus of claim 21, wherein the at least one memory and the computer program code are configured to, with the at least one processor, cause the apparatus to at least:
receive, by the transit node from a downstream node of the multicast tree, a membership discovery message including leaf membership information of the leaf node; and
send, by the transit node toward the root node, the membership discovery message.

29. The apparatus of claim 28, wherein the membership discovery message is sent based on a determination that the transit node is not the root node of the multicast tree.

30. The apparatus of claim 21, wherein the at least one memory and the computer program code are configured to, with the at least one processor, cause the apparatus to at least:
detect, by the transit node of the multicast tree, a condition associated with a loss of a multicast control plane session to a downstream peer; and
send, by the transit node toward a root node of the multicast tree based on detection of the condition associated with the loss of the multicast control plane session to the downstream peer, a second membership change message.

31. An apparatus, comprising:
at least one processor; and
at least one memory including computer program code;
wherein the at least one memory and the computer program code are configured to, with the at least one processor, cause the apparatus to at least:
receive, by a root node of a multicast tree from a transit node of the multicast tree, a membership change message indicative of a membership change in the multicast tree; and
send, by the root node of the multicast tree, a membership probe message indicative of a request by the root node for leaf nodes of the multicast tree to respond with indications of being members of the multicast tree.

32. The apparatus of claim 31, wherein the membership change message is received in-band via an upstream path of the multicast tree.

33. The apparatus of claim 31, wherein the membership probe message is sent in-band along a downstream path of the multicast tree.

34. The apparatus of claim 31, wherein the at least one memory and the computer program code are configured to, with the at least one processor, cause the apparatus to at least:
start, by the root node based on the membership probe message being sent, a membership discovery timer for the multicast tree, wherein the membership discovery timer is configured for use by the root node to identify an end of a leaf node discovery process.

35. The apparatus of claim 31, wherein the at least one memory and the computer program code are configured to, with the at least one processor, cause the apparatus to at least:
start, by the root node based on the membership probe message being sent, a membership probe suppression timer for the multicast tree;
receive, by the root node, a second membership change message indicative of a membership change in the multicast tree; and
suppress, by the root node based on the membership probe suppression timer, sending of a second membership probe message.

36. The apparatus of claim 35, wherein the at least one memory and the computer program code are configured to, with the at least one processor, cause the apparatus to at least:
send, by the root node based on expiration of the membership probe suppression timer, the second membership probe message.

37. The apparatus of claim 31, wherein the at least one memory and the computer program code are configured to, with the at least one processor, cause the apparatus to at least:
receive, by the root node from a leaf node of the multicast tree, a membership discovery message including leaf membership information of the leaf node for the multicast tree; and
register, by the root node in a leaf node membership database for the root node, the leaf membership information of the leaf node.

38. The apparatus of claim 37, wherein the membership discovery message is received in-band via an upstream path of the multicast tree.

39. The apparatus of claim 31, wherein the at least one memory and the computer program code are configured to, with the at least one processor, cause the apparatus to at least:
initiate, by the root node, a leaf node verification process configured to verify that the leaf nodes of the multicast tree are reachable in a data plane of the multicast tree.

40. An apparatus, comprising:
at least one processor; and
at least one memory including computer program code;
wherein the at least one memory and the computer program code are configured to, with the at least one processor, cause the apparatus to at least:
receive, by a leaf node of a multicast tree, a membership probe message indicative of a request by a root node of the multicast tree for the leaf node to respond with an indication of a membership status of the leaf node in the multicast tree; and
send, by the leaf node toward the root node based on the membership probe message, a membership discovery message including leaf membership information of the leaf node for the multicast tree.
